(19) United States
(12) Patent Application Publication
(10) Pub. No.: US 2020/0045983 A1
(43) Pub. Date: Feb. 13, 2020

(54) PROMOTER FOR LEGUMINOUS PLANT GROWTH

(71) Applicant: KAO CORPORATION, Tokyo (JP)

(72) Inventors: Yuhei TSUNO, Utsunomiya-shi (JP); Akinori OGAWA, Shimotsuga-gun (JP); Atsuki OHNISHI, Utsunomiya-shi (JP); Teruhisa FUJIMATSU, Utsunomiya-shi (JP); Jun DEGUCHI, Wakayama-shi (JP); Akihiro TANOUE, Wakayama-shi (JP)

(73) Assignee: KAO CORPORATION, Tokyo (JP)

(21) Appl. No.: 16/489,610

(22) PCT Filed: Feb. 20, 2018
(86) PCT No.: PCT/JP2018/006081

§ 371 Date: Aug. 28, 2019

(30) Foreign Application Priority Data
Mar. 1, 2017 (JP) 2017-037925
Nov. 21, 2017 (JP) 2017-223958
Feb. 20, 2018 (JP) 2018-028134

(51) Int. Cl. A01N 65/20; A01N 43/16; A01C 1/00; C05F 11/10

(52) U.S. Cl. CPC A01N 65/20; C05F 11/10; A01C 1/00; A01N 43/16

(57) ABSTRACT

It is intended to provide a component promoting the growth of leguminous plants. The present invention provides a promoter for leguminous plant growth comprising a glycoside of soyasapogenol B as an active ingredient, and a method for promoting the growth of a leguminous plant using a glycoside of soyasapogenol B as an active ingredient. The glycoside of soyasapogenol B is a glycoside having a hydroxy group at position C-22 of the soyasapogenol B and having a saccharide bonded to a hydroxy group at position C-3 of the soyasapogenol B.

### FIELD OF THE INVENTION

The present invention relates to a component promoting the growth of leguminous plants.

### BACKGROUND OF THE INVENTION

Leguminous plants such as soybean (Glycine max) are important plant resources which are widely cultivated and utilized throughout the world for food, for feed, or as raw materials of fat and oil, etc. Various types of leguminous plants are regularly eaten throughout the world. Increase in the yields of these leguminous plants is an important issue. It has been reported as to soybean that the weights of roots correlate significantly with yields among individuals of the same cultivar (Non Patent Literature 1). Increase in the weights of roots, i.e., underground part weights, not only leads directly to enhancement in the ability to supply nutrients (source ability) but contributes to the prevention of lodging of above-ground parts, and is therefore expected as a method for efficiently bringing about increase in the yields of the leguminous plants. In addition, root nodules are known as sources (nitrogen sources) of underground parts characteristic of the leguminous plants. It has been shown as to soybean that increase in the number of root nodules and root nodule weight leads to increase in yield (Non Patent Literature 2). Techniques of promoting root nodule formation are expected to be capable of achieving increased yields while suppressing use of chemical fertilizers, and are therefore desired also from the viewpoint of the construction of sustainable agricultural production systems.

Saponins are one type of glycoside contained in various plants and have heretofore been used as surfactants, emulsifiers, and the like. The structures of the saponins are diverse in their types, though broadly classified into triterpenoid saponin and steroid saponin.

The diverse structures of the saponins reflect their diverse physiological activities. Specifically, although the saponins have various physiological effects on animals and plants, these effects seem to differ depending on structures. For example, Quillaja saponins (Patent Literature 1) and saponins extracted from sponge gourd (Luffa cylindrica), Korean ginseng (Panax schinseng Nees), cucumber (Cucumis sativus), melon (Cucumis melo L.) or five-leaf ginseng (Gynostemma pentaphyllum Makino) (Patent Literature 2) have been reported to promote the growth of plants or to increase yields. As described, saponins derived from the seeds of tea (Thea sinensis) promote the infection of plants by vesicular arbuscular mycorrhizae which promotes the growth of the plants (Patent Literature 3).

Soyasaponins, one type of saponin, are an oleanane triterpenoid saponin and are characteristic metabolites contained in leguminous plants. However, there are many types of soyasaponins which differ largely in properties from each other. For example, among glycosides of soyasapogenol B, a glycoside having a saccharide bonded to a hydroxy group at position C-3 of soyasapogenol B and having a hydroxy group at position C-22 thereof (so-called group B soyasaponin), and a glycoside having a saccharide bonded to a hydroxy group at position C-3 of soyasapogenol B and having maltol bonded to a hydroxy group at position C-22 thereof (so-called DDMP saponin) differ largely in properties.

Non Patent Literature 3 has reported that DDMP saponin was involved in the removal of active oxygen or the promotion of root elongation in germinated soybean under experimentally controlled conditions, whereas group B soyasaponin had no influence on the growth of roots. Non Patent Literature 4 has reported that crude saponins derived from mung bean (Vigna radiata L.) promoted the rate of germination and initial growth of mung bean, but did not increase yields. Non Patent Literatures 5 and 6 have reported decrease in the seedling size of mung bean by mung bean-derived group B soyasaponin, and the inhibition of wheat (Triticum aestivum) seedling growth by alfalfa (Medicago media Pers.)-derived saponins. Non Patent Literatures 7 to 10 have also reported the influence of various soyasaponins on plant growth, but suggest that the effects differ depending on plant species or the structures of the soyasaponins. For example, it has been reported that soyasaponin βg (also called soyasaponin VI or chromosaponin I) which is DDMP saponin promoted lettuce (Lactuca sativa) radicle elongation, whereas this effect was relatively weak or was not seen in soyasaponin Bb (also called soyasaponin I) of group B. However, DDMP saponin is chemically unstable and requires a strict extraction step for its production (Non Patent Literature 11). Thus, DDMP saponin is very low practical for plant cultivation in actual agriculture due to stability problems in production and upon application.
(Patent Literature 1) JP-A-2004-121186
(Patent Literature 2) JP-A-61-15806
(Patent Literature 3) JP-A-8-23963
(Non Patent Literature 1) Report of the Hokkaido Branch, the Japanese Society of Breeding and Hokkaido Branch, the Crop Science Society of Japan, 1992, (31): 64
(Non Patent Literature 2) Bulletin of the National Institute of Crop Science, 2007, (8): 49-108
(Non Patent Literature 3) Seeds Science and Biotechnology, Society of Seed Physiology and Biochemistry (ed.), Gakkai Shuppan Center, 2009, pp. 106-112
(Non Patent Literature 4) Botanical Bulletin of Academia Sinica, 1995, 36 (1): 9-18
(Non Patent Literature 5) Advances in Plant Glycosides, Chemistry and Biology, Volume 6, Elsevier Science, 1999, pp. 105-130
(Non Patent Literature 6) Plant and Soil, 1987, 98 (1): 67-80
(Non Patent Literature 7) Physiol Plantarum, 1995, 93 (4): 785-789
(Non Patent Literature 8) Biologically Active Natural Products: Agrochemicals, CRC Press, 1999, pp. 248-272 (Non Patent Literature 9) Isoprenoid Synthesis in Plants and Microorganisms: New Concepts and Experimental Approaches, Springer, 2013, pp. 405-424
(Non Patent Literature 10) Phytochem Rev, 2013, (12): 877-893
(Non Patent Literature 11) Report of the Soy Protein Research Committee, 1994, (15): 36-40

### SUMMARY OF THE INVENTION

In one embodiment, the present invention provides a promoter for leguminous plant growth comprising a glycoside of soyasapogenol B as an active ingredient, the glycoside having a hydroxy group at position C-22 of the soyasapogenol B and having a saccharide bonded to a hydroxy group at position C-3 of the soyasapogenol B.

In another embodiment, the present invention provides a method for promoting the growth of a leguminous plant using a glycoside of soyasapogenol B as an active ingredient, the glycoside having a hydroxy group at position C-22 of the soyasapogenol B and having a saccharide bonded to a hydroxy group at position C-3 of the soyasapogenol B.

### BRIEF DESCRIPTION OF THE DRAWINGS

FIG. 1 shows the influence of soyasaponin Bb on the foliar age of soybean (Glycine max) cultivated in culture soil. Non-application plot: soyasaponin Bb non-application plot, and SSB: soyasaponin Bb application plot. Data is indicated by a mean of jars. Error bar=standard deviation (n=4).

FIG. 2 shows the influence of soyasaponin. Bb on the plant height of soybean cultivated in culture soil. The label of the abscissa is the same as in FIG. 1. Data is indicated by a mean of jars. Error bar=standard deviation (n=4).

FIG. 3 shows the influence of soyasaponin Bb on the number of lateral buds of soybean cultivated in culture soil. The label of the abscissa is the same as in FIG. 1. Data is indicated by a mean of jars. Error bar=standard deviation (n=4). *: P<0.05 (vs. non-application plot).

FIG. 4 shows the influence of soyasaponin Bb on the above-ground part fresh weight of soybean cultivated in culture soil. The label of the abscissa is the same as in FIG. 1. Data is indicated by a mean of jars. Error bar=standard deviation (n=4).

FIG. 5 shows the influence of soyasaponin Bb on the underground part fresh weight of soybean cultivated in culture soil. The label of the abscissa is the same as in FIG. 1. Data is indicated by a mean of jars. Error bar=standard deviation (n=4). *: P 0.05 (vs. non-application plot).

FIG. 6 shows the influence of soyasaponin Bb on the foliar age of soybean cultivated in culture soil under root nodule bacterium material application. Root nodule bacterium: only the root nodule bacterium material, root nodule bacterium+Gen: root nodule bacterium material+genistein application plot, and root nodule bacterium+SSB: root nodule bacterium material+soyasaponin Bb application plot. Data is indicated by a mean of jars. Error bar=standard deviation (n=4).

FIG. 7 shows the influence of soyasaponin Bb on the plant height of soybean cultivated in culture soil under root nodule bacterium material application. The label of the abscissa is the same as in FIG. 6. Data is indicated by a mean of jars. Error bar=standard deviation (n=4).

FIG. 8 shows the influence of soyasaponin Bb on the number of lateral buds of soybean cultivated in culture soil under root nodule bacterium material application. The label of the abscissa is the same as in FIG. 6. Data is indicated by a mean of jars. Error bar=standard deviation (n=4).

FIG. 9 shows the influence of soyasaponin Bb on the above-ground part fresh weight of soybean cultivated in culture soil under root nodule bacterium material application. The label of the abscissa is the same as in FIG. 6. Data is indicated by a mean of jars. Error bar=standard deviation (n=4).

FIG. 10 shows the influence of soyasaponin Bb on the underground part fresh weight of soybean cultivated in culture soil under root nodule bacterium material application. The label of the abscissa is the same as in FIG. 6. Data is indicated by a mean of jars. Error bar=standard deviation (n=4).

FIG. 11 shows the influence of soyasaponin Bb on the number of root nodules of soybean cultivated in culture soil under root nodule bacterium material application. The label of the abscissa is the same as in FIG. 6. Data is indicated by a mean of jars. Error bar=standard deviation (n=4).

FIG. 12 shows the influence of soyasaponin Bb on the root nodule fresh weight of soybean cultivated in culture soil under root nodule bacterium material application. The label of the abscissa is the same as in FIG. 6. Data is indicated by a mean of jars. Error bar=standard deviation (n=4).

FIG. 13 shows the influence of a soyasaponin Bb-containing soybean saponin formulation on the number of root nodules of soybean cultivated in culture soil under root nodule bacterium material application. Non-application plot: only the culture soil, root nodule bacterium: only the root nodule bacterium material, root nodule bacterium+S50: root nodule bacterium material+50 ppm of the soybean saponin formulation, root nodule bacterium+S100: root nodule bacterium material+100 ppm of the soybean saponin formulation, and root nodule bacterium+S500: root nodule bacterium material+500 ppm of the soybean saponin formulation. Data is indicated by a mean of jars. Error bar=standard deviation (n=3 or 4).

FIG. 14 shows the influence of a soyasaponin Bb-containing soybean saponin formulation on the root nodule fresh weight of soybean cultivated in culture soil under root nodule bacterium material application. The label of the abscissa is the same as in FIG. 13. Data is indicated by a mean of jars. Error bar=standard deviation (n=3 or 4).

FIG. 15 shows the influence of a soyasaponin Bb-containing soybean saponin formulation on the foliar age of soybean cultivated in culture soil under root nodule bacterium material application. The label of the abscissa is the same as in FIG. 13. Data is indicated by a mean of jars. Error bar=standard deviation (n=3 or 4).

FIG. 16 shows the influence of a soyasaponin Bb-containing soybean saponin formulation on the plant height of soybean cultivated in culture soil under root nodule bacterium material application. The label of the abscissa is the same as in FIG. 13. Data is indicated by a mean of jars. Error bar=standard deviation (n=3 or 4).

FIG. 17 shows the influence of a soyasaponin Bb-containing soybean saponin formulation on the above-ground part fresh weight of soybean cultivated in culture soil under root nodule bacterium material application. The label of the abscissa is the same as in FIG. 13. Data is indicated by a mean of jars. Error bar=standard deviation (n=3 or 4).

FIG. 18 shows the influence of a soyasaponin Bb-containing soybean saponin formulation on the underground part fresh weight of soybean cultivated in culture soil under root nodule bacterium application. Non-application plot: saponin formulation non-application plot, and formulation: saponin formulation application plot. Data is indicated by a mean of pots. Error bar standard deviation (n=6). *: P<0.05 (vs. non-application plot).

FIG. 19 shows the influence of a soyasaponin Bb-containing soybean saponin formulation on the number of grains of soybean cultivated in culture soil under root nodule bacterium application. Non-application plot: saponin formulation non-application plot, and formulation: saponin formulation application plot. Purified product: purified saponin formulation (Production Example 1) application plot. Data is indicated by a mean of pots. Error bar=standard deviation (n=5).

FIG. 20 shows the influence of a soyasaponin Bb-containing soybean saponin formulation on the grain fresh weight of soybean cultivated in culture soil under root nodule bacterium application. The label of the abscissa is the same as in FIG. 19. Data is indicated by a mean of pots. Error bar=standard deviation (n=5).

FIG. 21 shows the influence of a soyasaponin Bb-containing soybean saponin formulation (seed dressing) on the number of grains of soybean cultivated in culture soil under root nodule bacterium application. Non-application plot: saponin formulation non-application plot, and formulation: saponin formulation application plot. Data is indicated by a mean of pots. Error bar=standard deviation (n=10).

FIG. 22 shows the influence of a soyasaponin Bb-containing soybean saponin formulation (seed dressing) on the grain fresh weight of soybean cultivated in culture soil under root nodule bacterium application. The label of the abscissa is the same as in FIG. 21. Data is indicated by a mean of pots. Error bar=standard deviation (n=10).

FIG. 23 shows the influence of a soyasaponin Bb-containing soybean saponin formulation on the grain fresh weight of soybean cultivated in soil under root nodule bacterium application. Non-application plot: saponin formulation non-application plot, and formulation: saponin formulation application plot. Data is indicated by a mean of pots. Error bar=standard deviation (n=6).

FIG. 24 shows the influence of a soyasaponin Bb-containing soybean saponin formulation and catechin used in combination on the underground part dry weight of soybean. Non-application plot: saponin formulation non-application plot, saponin: saponin formulation application plot, catechin: catechin formulation application plot, and combination plot: saponin-catechin combination plot. Data is indicated by a mean of pots. Error bar=standard deviation (n=4 or 5).

FIG. 25 shows the influence of a soyasaponin Bb-containing soybean saponin formulation and iron phosphate used in combination on the pod weight per plant of soybean. Non-application plot: saponin formulation non-application plot, saponin: saponin formulation application plot, iron phosphate: iron(III) phosphate application plot, and combination plot: saponin-iron(III) phosphate combination plot. Data is indicated by a mean of pots. Error bar=standard deviation (n=7 or 8).

FIG. 26 shows the influence of a soyasaponin Bb-containing soybean saponin formulation and iron phosphate used in combination on the pod weight per pod of soybean. The label of the abscissa is the same as in FIG. 25. Data is indicated by a mean of pots. Error bar=standard deviation (n=7 or 8). *: significantly different (vs. non-application plot).

FIG. 27 shows the influence of a soyasaponin Bb-containing soybean saponin formulation and iron phosphate used in combination on the pod dry weight of soybean cultivated in non-cultivated land soil. Non-application plot: only the soil, and combination plot: saponin-iron(III) phosphate combination plot. Data is indicated by a mean of pots. Error bar=standard deviation (n=4 or 5).

FIG. 28 shows the influence of a soyasaponin Bb-containing soybean saponin formulation and iron phosphate used in combination on the grain dry weight of soybean cultivated in non-cultivated land soil. The label of the abscissa is the same as in FIG. 27. Data is indicated by a mean of pots. Error bar=standard deviation (n=4 or 5). *: significantly different (vs. non-application plot).

FIG. 29 shows the influence of a soyasaponin Bb-containing soybean saponin formulation on common bean (Phaseolus vulgaris) growth. Non-application plot: only a nutrient solution, 10 ppm: saponin formulation 10 ppm application plot, and 100 ppm: saponin formulation 100 ppm application plot. Data is indicated by a mean of pots. Error bar=standard deviation (n=5).

FIG. 30 shows the influence of a soyasaponin Bb-containing soybean saponin formulation on pea (Pisum sativum) growth. The label of the abscissa is the same as in FIG. 29. Data is indicated by a mean of pots. Error bar=standard deviation (n=5). *: significantly different (vs. non-application plot).

FIG. 31 shows the growth promotion of soybean by the foliar application of a soybean saponin formulation. Non-application plot: only culture soil, 10 ppm: saponin formulation 10 ppm application plot, and 100 ppm: saponin formulation 100 ppm application plot. Data is indicated by a mean. Error bar=standard deviation (n=14 or 15).

FIG. 32 shows the growth promotion of chickpea (Cicer arietinum) by the foliar application of a soybean saponin formulation. The label of the abscissa is the same as in FIG. 31. Data is indicated by a mean. Error bar=standard deviation (n=10 or 11).

FIG. 33 shows images of the photographed roots of leguminous plants which underwent the foliar application of a soybean saponin formulation. A: soybean and B: chickpea. Non-application plot: only culture soil, 10 ppm: saponin formulation 10 ppm application plot, and 100 ppm: saponin formulation 100 ppm application plot.

FIG. 34 shows increase in the root spread of soybean by the foliar application of a soybean saponin formulation. The label of the abscissa is the same as in FIG. 31. Data is indicated by a mean (n=14 or 15).

FIG. 35 shows increase in the root spread of chickpea by the foliar application of a soybean saponin formulation. The label of the abscissa is the same as in FIG. 31. Data is indicated by a mean (n=10 or 11).

### DETAILED DESCRIPTION OF THE INVENTION

There is a demand for the more efficient productivity, particularly, increase in the yield, of leguminous plants which are important crops. The present invention provides a component promoting the growth of leguminous plants.

The influence or effect of a glycoside of soyasapogenol B having a hydroxy group at position C-22 of the soyasapogenol B and having a saccharide bonded to a hydroxy group at position C-3 (so-called group B soyasaponin) on the growth of leguminous plants had not previously been elucidated. However, the present inventors found that the growth of leguminous plants is promoted by cultivation with soil, a material, water, or the like to which the group B soyasaponin is added.

The promoter for leguminous plant growth of the present invention promotes the growth of leguminous plants and brings about improvement in the productivity of leguminous plants which are important crops.

In the present invention, group B soyasaponin (i.e., a glycoside of soyasapogenol B having a hydroxy group at position C-22 of the soyasapogenol B and having a saccharide bonded to a hydroxy group at position C-3 of the soyasapogenol B) is used as an active ingredient in the growth promotion of a leguminous plant.

The “growth promotion” of the leguminous plant according to the present invention refers to any one or more factors selected from the group consisting of, for example, increase in the above-ground part and underground part weights of the leguminous plant, increase in the number of lateral buds, increase in yield, and the promotion of root nodule formation (e.g., increase in the number of root nodules or increase in root nodule weight). In the present invention, the “yield” refers to any one or more factors selected from the group consisting of increase in the number of flowers, the number of pods, pod weight, single seed weight, and the total weight of seeds per plant or per unit area (so-called seed harvest). Preferably, the “growth promotion” of the leguminous plant according to the present invention refers to any one or more factors selected from the group consisting of increase in underground part weight, increase in the number of lateral buds, increase in yield, and the promotion of root nodule formation, more preferably increase in yield, particularly, increase in the total weight of seeds per plant or per unit area (so-called seed harvest).

In the present specification, the “above-ground part” and the “underground part” of the leguminous plant refer to parts above and under, respectively, the upper surface of a cultivation substrate (e.g., soil, water, a nutrient solution, and a medium), in a leguminous plant body.

Examples of the “leguminous plant” include plants of the genus Glycine, plants of the genus Phaseolus, plants of the genus Cicer, plants of the genus Pisum, plants of the genus Lens, plants of the genus Cajanus, plants of the genus Vicia, plants of the genus Arachis, plants of the genus Medicago, plants of the genus Neptunia, plants of the genus Trigonella, and plants of the genus Psophocarpus. Preferred examples thereof include plants of the genus Glycine, plants of the genus Phaseolus, plants of the genus Cicer, plants of the genus Pisum, plants of the genus Lens, plants of the genus Cajanus, plants of the genus Vicia, and plants of the genus Arachis. More preferred examples thereof include plants of the genus Glycine, plants of the genus Phaseolus, plants of the genus Cicer, and plants of the genus Pisum. Further preferred examples thereof include plants of the genus Glycine.

Examples of the plant of the genus Glycine include soybean (Glycine max). Examples of the plant of the genus Phaseolus include common bean (Phaseolus vulgaris). Examples of the plant of the genus Cicer include chickpea (Cicer arietinum). Examples of the plant of the genus Pisum include pea (pea sprout) (Pisum sativum). Examples of the plant of the genus Lens include lentil (Lens culinaris). Examples of the plant of the genus Cajanus include pigeon pea (Cajanus cajan). Examples of the plant of the genus Vicia include broad bean (Vicia faba). Examples of the plant of the genus Arachis include peanut (Arachis hypogaea). Examples of the plant of the genus Medicago include alfalfa (Medicago sativa). Examples of the plant of the genus Neptunia include water mimosa (Neptunia oleracea). Examples of the plant of the genus Trigonella include fenugreek (Trigonella foenum-graecum). Examples of the plant of the genus Psophocarpus include Goa bean (Psophocarpus tetragonolobus).

In a preferred embodiment, the leguminous plant whose growth should be promoted according to the present invention is at least one member selected from the group consisting of a plant of the genus Glycine, a plant of the genus Phaseolus, a plant of the genus Cicer, a plant of the genus Pisum, a plant of the genus Lens, a plant of the genus Cajanus, a plant of the genus Vicia, and a plant of the genus Arachis. In a more preferred embodiment, the leguminous plant whose growth should be promoted according to the present invention is at least one member selected from the group consisting of soybean (Glycine max), common bean (Phaseolus vulgaris), chickpea (Cicer arietinum), pea (Pisum sativum), lentil (Lens culinaris), pigeon pea (Cajanus cajan), broad bean (Vicia faba) and peanut (Arachis hypogaea). Further preferably, the leguminous plant whose growth should be promoted according to the present invention is at least one member selected from the group consisting of soybean, common bean and chickpea, still further preferably soybean.

In the present specification, the group B soyasaponin is a glycoside of soyasapogenol B represented by the formula (I) given below, the glycoside having a hydroxy group at position C-22 of the soyasapogenol B and having a saccharide bonded to a hydroxy group at position C-3 of the soyasapogenol B. In the present specification, a glycoside having 2,3-dihydro-2,5-dihydroxy-6-methyl-4H-pyran-4-one bonded to a hydroxy group at position C-22 of the soyasapogenol B (so-called DDMP saponin) is not classified into the group B soyasaponin.

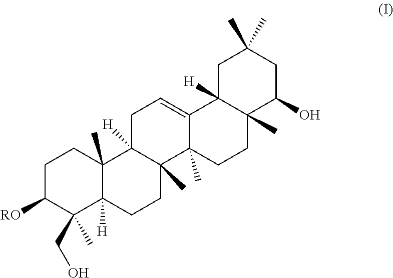

In the formula (I), R represents a saccharide residue or a saccharide chain.

Examples of the saccharide residue represented by R in the formula (I) include glucuronic acid, galactose, glucose, rhamnose, and arabinose. Examples of the saccharide chain represented by R include rhamnose(1→2)galactose(1→2)glucuronic acid(1→3), rhamnose(1→2)arabinose(1→2)glucuronic acid(1→3), and glucose(1→2)galactose(1→2)glucuronic acid(1→3).

Examples of the compound represented by the formula (I) preferably include soyasaponin Bb (also called soyasaponin I), soyasaponin Bc (also called soyasaponin II) and soyasaponin Ba (also called soyasaponin V), more preferably soyasaponin Bb. The structures of soyasaponin Bb, soyasaponin Bc and soyasaponin Ba are represented by the following formulas (II), (III) and (IV), respectively:

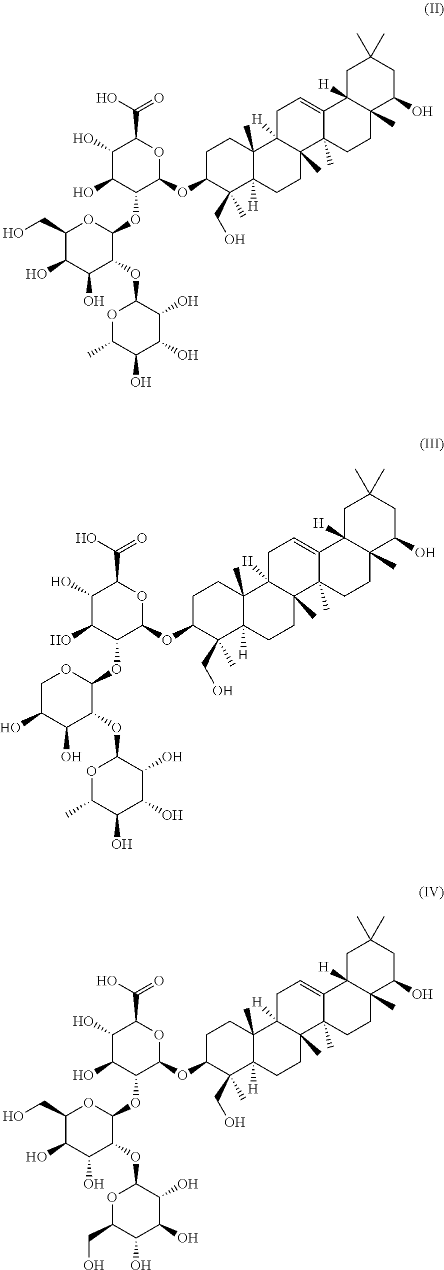

Thus, the active ingredient for leguminous plant growth promotion used in the present invention is a glycoside of soyasapogenol B having a hydroxy group at position C-22 of the soyasapogenol B and having a saccharide bonded to a hydroxy group at position C-3 of the soyasapogenol B, preferably one or more members selected from the group consisting of compounds represented by the formula (I), more preferably one or more members selected from the group consisting of soyasaponin Bb, soyasaponin Bc and soyasaponin Ba, further preferably soyasaponin Bb.

The group B soyasaponin used in the present invention can be prepared by extraction or purification from a leguminous plant such as soybean, or by secretion and production from a leguminous plant such as soybean. For example, in the case of extraction or purification from a leguminous plant, the group B soyasaponin can be isolated by grinding leguminous plant seeds such as dried soybean, followed by extraction with a solvent such as ethanol and, if necessary, purification through a column or a resin. For example, in the case of secretion and production from a leguminous plant, group B soyasaponin secreted into a hydroponic solution of a leguminous plant such as soybean can be used. Alternatively, commercially available group B soyasaponin (e.g., available from ChromaDex, Inc.) may be used. Alternatively, a commercially available soybean saponin formulation (e.g., available from Wako Pure Chemical Industries, Ltd., AccessOne Co., Ltd., J-Oil Mills, Inc., Fuji Oil Co., Ltd., Tokiwa Phytochemical Co., Ltd., or FAP Japan Co., Ltd.) rich in group B soyasaponin may also be used.

Thus, in one embodiment, the present invention provides a promoter for leguminous plant growth comprising group B soyasaponin as an active ingredient.

In an alternative embodiment, the present invention provides use of group B soyasaponin for the production of a promoter for leguminous plant growth.

In an alternative embodiment, the present invention provides use of group B soyasaponin for leguminous plant growth promotion.

In an alternative embodiment, the present invention provides group B soyasaponin for use in leguminous plant growth promotion.

In an alternative embodiment, the present invention provides a method for promoting the growth of a leguminous plant using group B soyasaponin.

In the present invention, the growth promotion preferably refers to any one or more factors selected from the group consisting of increase in underground part weight, increase in the number of lateral buds, increase in yield, and the promotion of root nodule formation, more preferably increase in yield, particularly, increase in the total weight of seeds per plant or per unit area.

In the leguminous plant growth promotion according to the present invention, the group B soyasaponin may be used alone, or may be used in the form of a composition comprising the group B soyasaponin as an active ingredient. Thus, the form of the promoter for leguminous plant growth provided by the present invention is not particularly limited, and may be, for example, the group B soyasaponin alone, or may be a composition (e.g., various agricultural or horticultural materials) comprising the group B soyasaponin as an active ingredient. The growth promoter of the present invention can have an arbitrary form, for example, a block, powder, granule, liquid, or gel form.

In the case of using group B soyasaponin alone, the group B soyasaponin can be added to a cultivation substrate for leguminous plant cultivation, such as soil, a medium, or a solution for nutriculture, or water or an additive comprising the group B soyasaponin can be prepared and added to the cultivation substrate for leguminous plants. Alternatively, water or an additive comprising the group B soyasaponin may be prepared and supplied to a leguminous plant seed or body.

Examples of the composition comprising the group B soyasaponin as an active ingredient include, but are not limited to, cultivation substrates (e.g., agricultural or horticultural soil, culture soil, media, solutions for nutriculture, and water), fertilizers, water for watering, microbial materials such as root nodule bacterium materials, soil conditioners, pesticides, materials for sowing, and supplements for plants (e.g., activators and nutrients) comprising the group B soyasaponin as an active ingredient.

The fertilizer, the microbial material, the soil conditioner, the material for sowing, or the supplement for plants comprising the group B soyasaponin as an active ingredient is preferred for contributing to improvement in soil for leguminous plant cultivation. The fertilizer, the microbial material, the soil conditioner, the material for sowing, or the supplement for plants may be a solid or may be a liquid. The fertilizer, the microbial material, the soil conditioner, the material for sowing, or the supplement for plants, when being a solid, may be a block, powder, or granule form or the like and is preferably a powder or granules. The fertilizer, the microbial material, the soil conditioner, the material for sowing, or the supplement for plants may comprise a component of a fertilizer, a microbial material, a soil conditioner, a material for sowing, or a supplement for plants usually used in leguminous plant cultivation, in addition to comprising the group B soyasaponin as an active ingredient.

The microbial material is preferably a root nodule bacterium material. The species of the root nodule bacterium comprised in the root nodule bacterium material can be selected according to the leguminous plant to be cultivated. Examples of the root nodule bacterium which may be comprised in the root nodule bacterium formulation used in the present invention, and the target leguminous plant thereof will be listed in Table 1 below. In the present specification, the microbe contained in the microbial material is also referred to as a microbial body.

TABLE 1

| Root nodule bacterium species | Leguminous plant |
|---|---|
| Genus Bradyrhizobium | Plant of genus Glycine, |
| for example, | for example, Glycine max (soybean) |
| Bradyrhizobium japonicum | Plant of genus Arachis, |
| Bradyrhizobium diazoefficiens | for example, Arachis hypogaea |
| Bradyrhizobium elkanii | (peanut) |
| Bradyrhizobium liaoningense | |
| Genus Ensifer (Sinorhizobium) | Plant of genus Glycine, |
| for example, | for example, Glycine max (soybean) |
| Ensifer (Sinorhizobium) fredii | |
| Genus Rhizobium | Plant of genus Phaseolus, |
| for example, | for example, Phaseolus vulgaris |
| Rhizobium leguminosarum | (common bean) |
| Rhizobium gallicum | Plant of genus Pisum, |
| Rhizobium giardinii | for example, Pisum sativum (pea) |
| | Plant of genus Vicia, |
| | for example, Vicia faba (broad bean) |
| | Plant of genus Lens, |
| | for example, Lens culinaris (lentil) |
| | Plant of genus Cajanus, |
| | for example, Cajanus cajan |
| | (pigeon pea) |
| Genus Mesorhizobium | Plant of genus Cicer, |
| for example, | for example, Cicer arietinum |
| Mesorhizobium ciceri | (chickpea) |
| Mesorhizobium mediterraneunn | |

Any one of the root nodule bacterium species listed above may be used alone, or any two or more thereof may be used in combination, for the respective target leguminous plants. For example, among the root nodule bacteria listed above, one or more members selected from the group consisting of a bacterium of the genus Bradyrhizobium and a bacterium of the genus Ensifer (Sinorhizobium) are preferred for the plant of the genus Glycine, and a bacterium of the genus Bradyrhizobium is more preferred therefor. The bacterium of the genus Bradyrhizobium is preferably one or more members selected from the group consisting of Bradyrhizobium japonicum, Bradyrhizobium diazoefficiens and Bradyrhizobium elkanii, more preferably one or more members selected from the group consisting of Bradyrhizobium japonicum and Bradyrhizobium diazoefficiens. The bacterium of the genus Ensifer (Sinorhizobium) is preferably Ensifer (Sinorhizobium) fredii.

The bacterium of the genus Rhizobium is preferred for the plant of the genus Phaseolus, the plant of the genus Pisum, the plant of the genus Vicia, the plant of the genus Lens, and the plant of the genus Cajanus. The bacterium of the genus Rhizobium is preferably one or more members selected from the group consisting of Rhizobium leguminosarum, Rhizobium gallicum and Rhizobium giardinii, more preferably Rhizobium leguminosarum.

The genus Mesorhizobium is preferred for the plant of the genus Cicer. The genus Mesorhizobium is preferably one or more members selected from the group consisting of Mesorhizobium ciceri and Mesorhizobium mediterraneum, more preferably Mesorhizobium ciceri.

The bacterium of the genus Bradyrhizobium is preferred for the plant of the genus Arachis. The preferred bacterial species of the genus Bradyrhizobium is the same as in the case of the plant of the genus Glycine.

A material of a microbial species other than the root nodule bacterium may be used as the microbial material, or a material of the root nodule bacterium combined with a microbial species other than the root nodule bacterium may be used. Examples of the microbial species other than the root nodule bacterium include plant growth-promoting rhizospheric bacteria and plant growth-promoting fungi. Examples of the plant growth-promoting rhizospheric bacterium include bacteria of the genus Bacillus, bacteria of the genus Pseudomonas, bacteria of the genus Azospirillum, bacteria of the genus Burkholderia, bacteria of the genus Enterobacter, bacteria of the genus Talaromyces, bacteria of the genus Arthrobacter, bacteria of the genus Agrobacteria, bacteria of the genus Corynebacteria, bacteria of the genus Erwinia, bacteria of the genus Psychrobacter, bacteria of the genus Serratia and bacteria of the genus Rhodococcus. Examples of the plant growth-promoting fungus include fungi of the genus Penicillium, fungi of the genus Trichoderma, fungi of the genus Fusarium, fungi of the genus Phoma, fungi of the genus Glomus, fungi of the genus Acaulospora, fungi of the genus Entrophospora, fungi of the genus Gigaspora, fungi of the genus Scutellospora and fungi of the genus Aspergillus.

The cultivation substrate, the fertilizer, the microbial material such as a root nodule bacterium material, the soil conditioner, the pesticide, the material for sowing, or the supplement for plants comprising the group B soyasaponin as an active ingredient may be prepared by adding the group B soyasaponin to a usual cultivation substrate (e.g., agricultural or horticultural soil, culture soil, a medium, a solution for nutriculture, and water), fertilizer, microbial material such as root nodule bacterium material, soil conditioner, pesticide, material for sowing, supplement for plants (e.g., activator and nutrient), or the like.

The concentration of the group B soyasaponin in the aforementioned composition comprising the group B soyasaponin as an active ingredient is preferably 0.0005% by mass or higher, more preferably 0.005% by mass or higher, and preferably 80% by mass or lower, more preferably 50% by mass or lower, further preferably 5% by mass or lower, still further preferably 0.5% by mass or lower, in the total amount of the composition, or is preferably from 0.0005 to 80% by mass, more preferably from 0.0005 to 50% by mass, from 0.0005 to 5% by mass, from 0.0005 to 0.5% by mass, from 0.005 to 80% by mass, from 0.005 to 50% by mass, from 0.005 to 5% by mass or from 0.005 to 0.5% by mass, in the total amount of the composition when the composition is, for example, a fertilizer, a microbial material, a soil conditioner, a material for sowing, or a supplement for plants. Alternatively, the concentration of the group B soyasaponin in the composition is preferably 0.01 ppm by mass or higher, more preferably 0.1 ppm by mass or higher, and preferably 100 ppm by mass or lower, more preferably 10 ppm by mass or lower, further preferably 5 ppm by mass or lower, still further preferably 2 ppm by mass or lower in the total amount of the composition, or is preferably from 0.01 to 100 ppm by mass, more preferably from 0.01 to 10 ppm by mass, from 0.01 to 5 ppm by mass, from 0.01 to 2 ppm by mass, from 0.1 to 100 ppm by mass, from 0.1 to 10 ppm by mass, from 0.1 to 5 ppm by mass or from 0.1 to 2 ppm by mass, in the total amount of the composition when the composition is a cultivation substrate.

The amount of the group B soyasaponin used for the growth promotion of the leguminous plant according to the present invention can be preferably from 0.01 to 100 ppm by mass, more preferably from 0.01 to 50 ppm by mass, from 0.01 to 20 ppm by mass, from 0.01 to 13 ppm by mass, from 0.1 to 10 ppm by mass, from 0.1 to 5 ppm by mass or from 0.1 to 2 ppm by mass, in terms of a concentration in the cultivation substrate for leguminous plant cultivation. For example, the amount of the group B soyasaponin used per liter of the cultivation substrate can be preferably from 0.01 to 100 mg, more preferably from 0.01 to 50 mg, from 0.01 to 20 mg, from 0.01 to 13 mg, from 0.1 to 10 mg, from 0.1 to 5 mg or from 0.1 to 2 mg. In the case of soil-cultivating the leguminous plant, the group B soyasaponin can be added to soil in an amount of preferably from 0.001 to 10 kg, more preferably from 0.001 to 5 kg, from 0.001 to 2 kg, from 0.001 to 1.3 kg, from 0.01 to 1 kg, from 0.01 to 0.5 kg or from 0.01 to 0.2 kg per 10 a of land. Specifically, in the case of the composition, for example, the fertilizer, the microbial material, the soil conditioner, the material for sowing, or the supplement for plants, comprising the group B soyasaponin as an active ingredient, the amount of the composition used depends on the concentration of the group B soyasaponin comprised in the composition. If the concentration of the group B soyasaponin comprised in the composition is 0.005% by mass, the amount of the composition used per 10 a of land is preferably from 20 to 200,000 kg, more preferably from 20 to 100,000 kg, from 20 to 40,000 kg, from 20 to 26,000 kg, from 200 to 20,000 kg, from 200 to 10,000 kg or from 200 to 4,000 kg.

In the present invention, examples of the approach of cultivating the leguminous plant include nutriculture such as hydroponics, aeroponics, sand culture, and gravel culture, soil culture, and drip fertigation. Among them, soil culture is preferred. In the soil culture, agricultural or horticultural soil or culture soil is preferably used. The soil or the culture soil for use in the soil culture preferably has undergone soil improvement such as aggregation treatment. A soil conditioner comprising alkali-treated lignin as an active ingredient, described in JP-A-2017-190448 is preferred as a soil conditioner for the aggregation treatment of the soil or the culture soil.

The cultivation of the leguminous plant according to the present invention is preferably indoor cultivation from the viewpoint of environmental stability and is more preferably outdoor cultivation from the viewpoint of securing yields. In the case of cultivation by any approach, group B soyasaponin (alone or in the form of the aforementioned composition comprising the group B soyasaponin as an active ingredient) is used as an active ingredient in the method for promoting the growth of a leguminous plant according to the present invention. Specifically, the leguminous plant is cultivated with the group B soyasaponin. In one embodiment of the method of the present invention, the group B soyasaponin is preferably added to a cultivation substrate (e.g., soil, culture soil, a medium, a solution for nutriculture, and water). The effect of promoting leguminous plant growth by the group B soyasaponin can be obtained by cultivating the leguminous plant according to usual procedures in the cultivation substrate comprising the group B soyasaponin. For example, in soil culture, a fertilizer, a root nodule bacterium material, or the like usually applied to leguminous plants is added, if necessary, to soil, and the group B soyasaponin can be applied thereto. Alternatively, in the case of using the group B soyasaponin in a form such as a fertilizer or a microbial material, this may be combined with the addition of another fertilizer, microbial material, or the like, though it is not necessary to separately add a fertilizer, a microbial material, or the like. The effect of promoting growth by the group B soyasaponin can be acquired by cultivating the leguminous plant according to usual procedures in the prepared soil to which the group B soyasaponin is added. In the case of nutriculture, the group B soyasaponin may be added into a nutrient solution. The addition of the group B soyasaponin to the cultivation substrate is preferably performed before sowing. The group B soyasaponin may be added thereto after sowing, or may be added thereto both before sowing and after sowing.

In an alternative embodiment of the method of the present invention, the group B soyasaponin is preferably supplied by coating or smearing therewith a seed before sowing (e.g., as seed dressing). The effect of promoting leguminous plant growth by the group B soyasaponin can be obtained by cultivating the seed to which the group B soyasaponin is added in the cultivation substrate according to usual procedures. In a further alternative embodiment, the addition of the group B soyasaponin to the cultivation substrate (e.g., soil, culture soil, a medium, a solution for nutriculture, and water) before sowing and/or after sowing may be combined with the coating or smearing of a seed before sowing with the group B soyasaponin.

In a further embodiment of the method of the present invention, the group B soyasaponin may be supplied by direct distribution or spraying to a leguminous plant body or direct coating thereof (e.g., foliar application). The effect of promoting leguminous plant growth by the group B soyasaponin can be obtained by cultivating the leguminous plant to which the group B soyasaponin is added, according to usual procedures. In a further alternative embodiment, the addition of the group B soyasaponin to the cultivation substrate (e.g., soil, culture soil, a medium, a solution for nutriculture, and water) before sowing and/or after sowing, or the coating or smearing of a seed before sowing with the group B soyasaponin may be combined with the direct distribution or spraying of the group B soyasaponin to a leguminous plant body or the direct coating of the leguminous plant body therewith.

The cultivation period of the leguminous plant in the method of the present invention is preferably 20 days or longer from the sowing of seeds, more preferably until the time when seeds are harvestable. However, the period necessary until the time when seeds are harvestable differs depending on the type of the leguminous plant or a cultivation environment.

In the present invention, the group B soyasaponin may be used in combination with one or more members selected from the group consisting of other components for leguminous plant growth promotion, for example, an essential plant nutrient, a flavonoid, an organic acid, an amino acid, a peptide, a nucleoside, a nucleotide, a nucleobase, a saccharide, a monohydric alcohol, a nonionic surfactant, a food additive, a microbial extract, a plant hormone, a nod factor, i.e., a lipo-chitooligosaccharide, a synthetic lipo-chitooligosaccharide, a chitooligosaccharide, a chitinous compound, linoleic acid or a derivative thereof, linolenic acid or a derivative thereof, a karrikin, an acyl-homoserine lactone derivative, a betaine compound, and a phenol compound. These other components may be comprised in the aforementioned composition comprising the group B soyasaponin, or may be separately applied to the leguminous plant. The amount of these other components used can be an amount which does not inhibit the effect of promoting leguminous plant growth by the group B soyasaponin.

Examples of the essential plant nutrient include: nitrogen, phosphorus, potassium, calcium, sulfur, magnesium, boron, chlorine, manganese, iron, zinc, copper, molybdenum, and nickel. Examples of the flavonoid include genistin, genistein, and daidzein. Examples of the organic acid include citric acid, oxalic acid, ferulic acid, caffeic acid, malic acid, malonic acid, piscidic acid, mugineic acid, dehydroxymugineic acid, hydroxymugineic acid, acetic acid, and butyric acid. Examples of the amino acid include serine, proline, leucine, isoleucine, methionine, cysteine, tryptophan, asparagine, glutamine, aspartic acid, glutamic acid, and 5-aminolevulinic acid. Examples of the peptide include glutathione, glycopeptides, soy protein isolates, and plant-derived polypeptides. Examples of the nucleoside include inosine, guanosine, and uridine. Examples of the nucleotide include inosinic acid, guanylic acid, and uridylic acid. Examples of the nucleobase include hypoxanthine, guanine, and uracil. Examples of the saccharide include trehalose, sucrose, glucose, and maltose. Examples of the monohydric alcohol include alcohol lauryl alcohol; cetyl stearyl alcohol, and oleyl alcohol. Examples of the nonionic surfactant include polyoxyethylene oleyl ether, polyoxyethylene lauryl ether and, polyoxyethylene stearyl ether. Examples of the food additive include chitosan. Examples of the microbial extract include yeast extracts. Examples of the plant hormone include indole-3-acetic acid, indole-3-butyric acid, naphthaleneacetic acid, naphthoxyacetic acid, phenylacetic acid, 2,4-dichlorophenoxyacetic acid, 2,4,5-trichlorophenoxyacetic acid, zeatin, kinetin, benzyladenine, thidiazuron, gibberellin, strigolactone, jasmonic acid, and methyl jasmonate. Examples of the nod factor, i.e., the lipo-chitooligosaccharide, include NodRM, NodRM-1, and NodRM-3, BjNod-V (C18:1), BjNod-V (Ac, C18:1), BjNod-V (C16:1) and BjNod-V (Ac, C16:0) described in U.S. Pat. Nos. 5,175,149 and 5,321,011, and Myc factors described in WO2010/049751. Examples of the synthetic lipo-chitooligosaccharide include synthetic LCO compounds described in WO2005/063784, and AcNodRM-1 and AcNodRM-3 described in U.S. Pat. No. 5,545,718. Examples of the chitooligosaccharide include oligo-N-acetylglucosamine. Examples of the chitinous compound include chitin and chitosan. Examples of the linoleic acid or the derivative thereof include linoleic acid. Examples of the linolenic acid or the derivative thereof include linolenic acid. Examples of the karrikin include hydrochloride and hydrobromide. Examples of the acyl-homoserine lactone derivative include N-acyl-L-homoserine lactone, N-hexanoyl-L-homoserine lactone, and N-(3-oxooctanoyl)-L-homoserine lactone. Examples of the betaine compound include N,N,N-trimethylglycine and carnitine. Examples of the phenol compound include cresol and chlorophenol.

In a preferred embodiment, the group B soyasaponin for leguminous plant growth promotion according to the present invention is used in combination with a catechin. In the present specification, the catechin means at least one member selected from the group consisting of catechin (C), gallocatechin (GC), catechin gallate (Cg), gallocatechin gallate (GCg), epicatechin (EC), epigallocatechin (EGC), epicatechin gallate (ECg), and epigallocatechin gallate (EGCg). The catechin can be extracted from, for example, a tea leaf produced from a plant of the genus Camellia (e.g., C. sinensis var. sinensis and C. sinensis var. assamica), grapes, cacao beans, or a processed product thereof. Alternatively, a commercially available tea extract or catechin formulation can be used as the catechin. In an alternative preferred embodiment, the group B soyasaponin for leguminous plant growth promotion according to the present invention is used in combination with iron(III) phosphate (FePO₄).

All patent literatures, non patent literatures, and other publications cited herein are incorporated herein by reference in their entirety.

The following substance, production method, use, method, etc. will be further disclosed herein as exemplary embodiments of the present invention. However, the present invention is not limited by these embodiments.

[1] A promoter for leguminous plant growth comprising a glycoside of soyasapogenol B as an active ingredient, the glycoside having a hydroxy group at position C-22 of the soyasapogenol B and having a saccharide bonded to a hydroxy group at position C-3 of the soyasapogenol. B.

[2] The promoter for leguminous plant growth according to [1], further comprising

preferably one or more members selected from the group consisting of an essential plant nutrient, a flavonoid, an organic acid, an amino acid, a peptide, a nucleoside, a nucleotide, a nucleobase, a saccharide, a monohydric alcohol, a nonionic surfactant, a food additive, a microbial extract, a plant hormone, a nod factor, i.e., a lipo-chitooligosaccharide, a synthetic lipo-chitooligosaccharide, a chitooligosaccharide, a chitinous compound, linoleic acid or a derivative thereof, linolenic acid or a derivative thereof, a karrikin, an acyl-homoserine lactone derivative, a betaine compound, and a phenol compound,

more preferably a catechin or iron(III) phosphate.

[3] The promoter for leguminous plant growth according to [1] or [2], wherein the promoter for leguminous plant growth is preferably in the form of a pesticide for leguminous plants, a fertilizer, a microbial material, a soil conditioner, a material for sowing or a supplement for plants.

[4] The promoter for leguminous plant growth according to [3], wherein the microbial material is preferably a root nodule bacterium material.

[5] The promoter for leguminous plant growth according to [3] or [4], wherein the promoter for leguminous plant growth preferably comprises from 0.0005 to 80% by mass of the glycoside.

[6] The promoter for leguminous plant growth according to [1] or [2], wherein the promoter for leguminous plant growth is preferably a cultivation substrate for leguminous plants.

[7] The promoter for leguminous plant growth according to [6], wherein the cultivation substrate is preferably soil, culture soil, a medium, a solution for nutriculture or water.

[8] The promoter for leguminous plant growth according to [6] or [7], wherein the promoter for leguminous plant growth preferably comprises from 0.01 to 100 ppm by mass of the glycoside.

[9] The promoter for leguminous plant growth according to any one of [1] to [8], wherein the growth promotion is preferably any one or more factors selected from the group consisting of increase in underground part weight, increase in the number of lateral buds, the promotion of root nodule formation and increase in yield, more preferably increase in yield.

[10] Use of a glycoside of soyasapogenol B for the production of a promoter for leguminous plant growth, the glycoside having a hydroxy group at position C-22 of the soyasapogenol B and having a saccharide bonded to a hydroxy group at position C-3 of the soyasapogenol B.

[11] The use according to [10], wherein the promoter for leguminous plant growth further comprises

preferably one or more members selected from the group consisting of an essential plant nutrient, a flavonoid, an organic acid, an amino acid, a peptide, a nucleoside, a nucleotide, a nucleobase, a saccharide, a monohydric alcohol, a nonionic surfactant, a food additive, a microbial extract, a plant hormone, a nod factor, i.e., a lipo-chitooligosaccharide, a synthetic lipo-chitooligosaccharide, a chitooligosaccharide, a chitinous compound, linoleic acid or a derivative thereof, linolenic acid or a derivative thereof, a karrikin, an acyl-homoserine lactone derivative, a betaine compound, and a phenol compound,

more preferably a catechin or iron(III) phosphate.

[12] The use according to [10] or [11], wherein the promoter for leguminous plant growth is preferably a pesticide for leguminous plants, a fertilizer, a microbial material, a soil conditioner, a material for sowing or a supplement for plants.

[13] The use according to [12], wherein the microbial material is preferably a root nodule bacterium material.

[14] The use according to [12] or [13], wherein the promoter for leguminous plant growth preferably comprises from 0.0005 to 80% by mass of the glycoside.

[15] The use according to [10] or [11], wherein the promoter for leguminous plant growth is preferably a cultivation substrate for leguminous plants.

[16] The use according to [15], wherein the cultivation substrate is preferably soil, culture soil, a medium, a solution for nutriculture or water.

[17] The use according to [15] or [16], wherein the promoter for leguminous plant growth preferably comprises from 0.01 to 100 ppm by mass of the glycoside.

[18] The use according to any one of [10] to [17], wherein the growth promotion is preferably any one or more factors selected from the group consisting of increase in underground part weight, increase in the number of lateral buds, the promotion of root nodule formation and increase in yield, more preferably increase in yield.

[19] Use of a glycoside of soyasapogenol B for leguminous plant growth promotion, the glycoside having a hydroxy group at position C-22 of the soyasapogenol B and having a saccharide bonded to a hydroxy group at position C-3 of the soyasapogenol B.

[20] The use according to [19], wherein the glycoside is preferably used in combination with

one or more members selected from the group consisting of an essential plant nutrient, a flavonoid, an organic acid, an amino acid, a peptide, a nucleoside, a nucleotide, a nucleobase, a saccharide, a monohydric alcohol, a nonionic surfactant, a food additive, a microbial extract, a plant hormone, a nod factor, i.e., a lipo-chitooligosaccharide, a synthetic lipo-chitooligosaccharide, a chitooligosaccharide, a chitinous compound, linoleic acid or a derivative thereof, linolenic acid or a derivative thereof, a karrikin, an acyl-homoserine lactone derivative, a betaine compound, and a phenol compound,

more preferably a catechin or iron(III) phosphate.

[21] The use according to [19] or [20], wherein the glycoside is preferably comprised in a pesticide for leguminous plants, a fertilizer, a microbial material, a soil conditioner, a material for sowing or a supplement for plants.

[22] The use according to [21], wherein the microbial material is preferably a root nodule bacterium material.

[23] The use according to [21] or [22], wherein the pesticide, the fertilizer, the microbial material, the soil conditioner, the material for sowing or the supplement for plants preferably comprises from 0.0005 to 80% by mass of the glycoside.

[24] The use according to [19] or [20], wherein the glycoside is preferably comprised in a cultivation substrate for leguminous plants.

[25] The use according to [24], wherein the cultivation substrate is preferably soil, culture soil, a medium, a solution for nutriculture or water.

[26] The use according to [24] or [25], wherein the cultivation substrate preferably comprises from 0.01 to 100 ppm by mass of the glycoside.

[27] The use according to any one of [19] to [26], wherein the growth promotion is preferably any one or more factors selected from the group consisting of increase in underground part weight, increase in the number of lateral buds, the promotion of root nodule formation and increase in yield, more preferably increase in yield.

[28] A method for cultivating a leguminous plant comprising using a glycoside of soyasapogenol B as an active ingredient, the glycoside having a hydroxy group at position C-22 of the soyasapogenol B and having a saccharide bonded to a hydroxy group at position C-3 of the soyasapogenol B.

[29] A method for promoting the growth of a leguminous plant comprising using a glycoside of soyasapogenol B as an active ingredient, the glycoside having a hydroxy group at position C-22 of the soyasapogenol B and having a saccharide bonded to a hydroxy group at position C-3 of the soyasapogenol B.

[30] The method according to [28] or [29], wherein the glycoside is used in combination with

preferably one or more members selected from the group consisting of an essential plant nutrient, a flavonoid, an organic acid, an amino acid, a peptide, a nucleoside, a nucleotide, a nucleobase, a saccharide, a monohydric alcohol, a nonionic surfactant, a food additive, a microbial extract, a plant hormone, a nod factor, i.e., a lipo-chitooligosaccharide, a synthetic lipo-chitooligosaccharide, a chitooligosaccharide, a chitinous compound, linoleic acid or a derivative thereof, linolenic acid or a derivative thereof, a karrikin, an acyl-homoserine lactone derivative, a betaine compound, and a phenol compound,

more preferably a catechin or iron(III) phosphate.

[31] The method according to any one of [28] to [30], preferably comprising cultivating the leguminous plant with the glycoside of soyasapogenol B.

[32] The method according to [31], preferably comprising:

adding the glycoside of soyasapogenol B as an active ingredient to a cultivation substrate; and

cultivating the leguminous plant in the obtained cultivation substrate to which the glycoside is added.

[33] The method according to [31], preferably comprising:

coating or smearing a leguminous plant seed before sowing with the glycoside of soyasapogenol B as an active ingredient; and

cultivating the seed in a cultivation substrate.

[34] The method according to [31], preferably comprising:

distributing or spraying the glycoside of soyasapogenol B as an active ingredient to a leguminous plant body, or coating the leguminous plant body therewith; and

cultivating the plant body in a cultivation substrate.

[35] The method according to [32], wherein the addition of the glycoside of soyasapogenol B to the cultivation substrate preferably comprises adding a pesticide, a fertilizer, a microbial material, a soil conditioner, a material for sowing or a supplement for plants comprising the glycoside as an active ingredient to the cultivation substrate.

[36] The method according to [33], wherein the coating or smearing of the leguminous plant seed with the glycoside of soyasapogenol B preferably comprises coating or smearing the seed with a pesticide, a fertilizer, a microbial material, a soil conditioner, a material for sowing or a supplement for plants comprising the glycoside as an active ingredient.

[37] The method according to [34], wherein the distribution or spraying of the glycoside of soyasapogenol B to the leguminous plant body, or the coating of the leguminous plant body therewith preferably comprises distributing or spraying a pesticide, a fertilizer, a microbial material, a soil conditioner, a material for sowing or a supplement for plants comprising the glycoside as an active ingredient to the plant body, or coating the plant body therewith.

[38] The method according to any one of [35] to [37], wherein the pesticide, the fertilizer, the microbial material, the soil conditioner, the material for sowing or the supplement for plants preferably comprises from 0.0005 to 80% by mass of the glycoside of soyasapogenol B.

[39] The method according to any one of [31] to [38], wherein for the cultivation, a concentration of the glycoside in the cultivation substrate is preferably from 0.01 to 100 ppm by mass.

[40] The method according to any one of [31] to [39], wherein the cultivation substrate in the cultivation is preferably soil, culture soil, a medium, a solution for nutriculture or water.

[41] The method according to any one of [29] to [40], wherein the growth promotion is preferably any one or more factors selected from the group consisting of increase in underground part weight, increase in the number of lateral buds, the promotion of root nodule formation and increase in yield, more preferably increase in yield.

[42] The method according to any one of [28] to [41], wherein soil or culture soil aggregated using alkali-treated lignin is preferably used as a cultivation substrate.

[43] The method according to any one of [28] to [42], wherein the glycoside is preferably used in combination with a microbial body or a microbial material.

[44] In any one of the above [1] to [43],

the glycoside of soyasapogenol B is

preferably a compound represented by the formula (I) wherein R is

a saccharide residue or a saccharide chain,
preferably a saccharide residue selected from the group consisting of glucuronic acid, galactose, glucose, rhamnose and arabinose, or a saccharide chain selected from the group consisting of
rhamnose(1→2)galactose(1→2)glucuronic acid(1→3), rhamnose(1→2)arabinose(1→2)glucuronic acid(1→3), and glucose(1→2)galactose(1→2)glucuronic acid(1→3);

more preferably at least one member selected from the group consisting of soyasaponin Bb, soyasaponin Bc and soyasaponin Ba;

further preferably soyasaponin Bb.

[45] In any of the above [1] to [44],

the leguminous plant is

preferably at least one member selected from the group consisting of a plant of the genus Glycine, a plant of the genus Phaseolus, a plant of the genus Cicer, a plant of the genus Pisum, a plant of the genus Lens, a plant of the genus Cajanus, a plant of the genus Vicia, and a plant of the genus Arachis,

more preferably at least one member selected from the group consisting of soybean (Glycine max), common bean (Phaseolus vulgaris), chickpea (Cicer arietinum), pea (Pisum sativum), lentil (Lens culinaris), pigeon pea (Cajanus cajan), broad bean (Vicia faba) and peanut (Arachis hypogaea).

[46] In any one of the above [7], [16], [25] and [40], the soil is preferably soil or culture soil aggregated using alkali-treated lignin.

### EXAMPLES

Hereinafter, the present Invention will be described in more detail with reference to Examples. However, the present invention is not limited by these examples.

### Example 1

(Effect of Soyasaponin Bb on Soybean (Glycine max) Growth)

Each Leonard jar (Soil Science and Plant Nutrition, 1983, 29: 97-100) filled with approximately 65 g of culture soil (Takii water-containing cell culture soil TM-1, Takii & Co., Ltd.) was irrigated with 100 mL of tap water. Then, two seeds of soybean (cultivar “Ryokuheki”, Kaneko Seeds Co., Ltd.) were sown by burying at a depth of approximately 1 cm from the culture soil surface. 1 mL of a solution of 20 μM soyasaponin Bb (soyasaponin I, ChromaDex, Inc.) dissolved in 50 mM TAPS buffer (pH 7.7) was added dropwise onto the culture soil covering the seeds using a micropipette. The soyasaponin Bb concentration in the culture soil was approximately 0.3 ppm (ppm by mass; the same holds true for the description below). 50 mM TAPS buffer (pH 7.7) was applied as a control (soyasaponin Bb non-application plot) in the same way as above.

Plant cultivation was performed in a plant growth chamber (LPH-350SP, Nippon Medical & Chemical Instruments Co., Ltd.). The light conditions were set to 16-hour light (light intensity: 130 μmol/m²/s)/8-hour dark. The temperature was set to 26° C. for light and 20° C. for dark, and the humidity was set to 50%. Water supply was performed appropriately (approximately once per 7 to 10 days) by the addition of tap water in an appropriate amount to the lower part of the jar. 24 days after the sowing, growth indexes (foliar age, plant height, the number of lateral buds, above-ground part fresh weight, and underground part fresh weight) were measured. Each growth index was obtained as to each of the soyasaponin Bb non-application plot (control) and the soyasaponin Bb application plot by determining a mean of two plant individuals in each jar, and subsequently calculating a mean of four jars (n=4). The Student's t test was used to test the significant difference between the soyasaponin Bb application plot and the non-application plot.

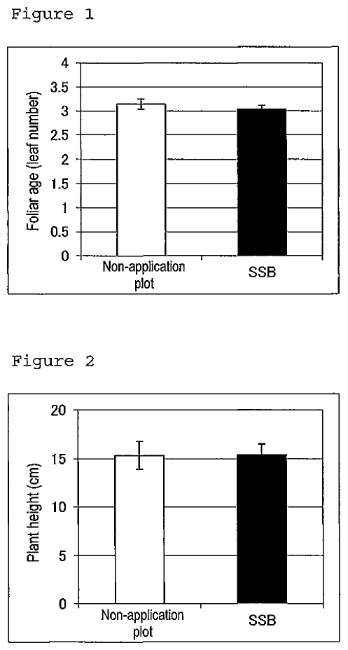

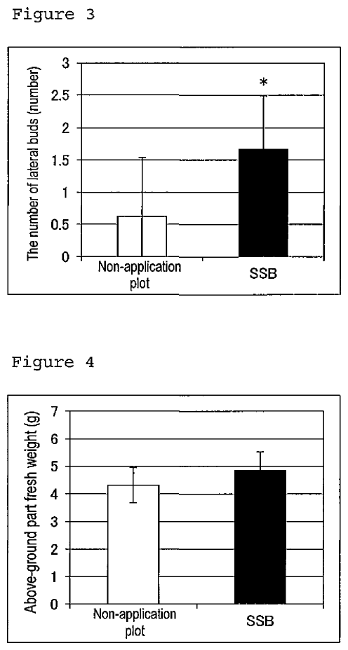

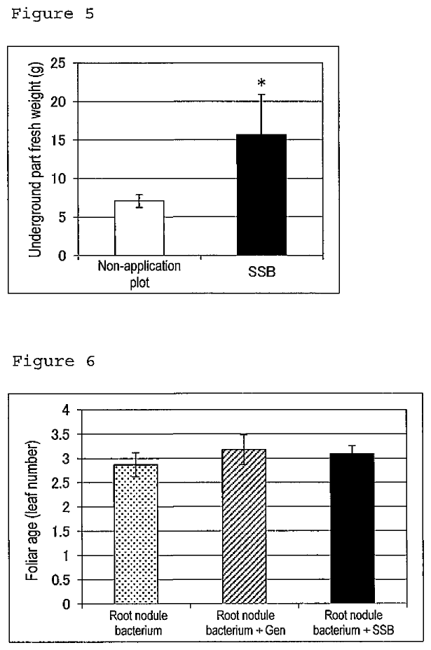

The measurement results are shown in FIGS. 1 to 5. In the figures, “SSB” represents the soyasaponin Bb application plot, and “non-application plot” represents the soyasaponin Bb non-application plot. In the soyasaponin Bb application plot, statistically significant increase in the number of lateral buds (approximately 2.7 times with respect to the non-application plot) and increase in underground part fresh weight (approximately 2.2 times with respect to the non-application plot) were observed (FIGS. 3 and 5). A tendency toward increase in above-ground part fresh weight (approximately 1.1 times) was also observed, albeit with no significant difference (FIG. 4). The foliar age and the plant height did not differ significantly between the soyasaponin Bb application plot and the non-application plot, and their values were not decreased by the addition of soyasaponin Bb (FIGS. 1 and 2). The application of soyasaponin Bb was confirmed to significantly increase the underground part weight, which is a growth index related to increase in the seed harvest of soybean (see Non Patent Literature 1). Therefore, it was expected that the application of soyasaponin Bb to soybean is capable of increasing the seed harvest of soybean.

### Example 2

(Effect of Soyasaponin Bb on Soybean (Glycine max) Growth: Used in Combination with Root Nodule Bacterium Material)

Each Leonard jar filled with culture soil (Takii water-containing cell culture soil TM-1, Takii & Co., Ltd.) was irrigated with 100 mL of tap water. Then, a root nodule bacterium material (“Dr Mametaro®” (Idemitsu Kosan Co., Ltd.) was distributed at a thickness on the order of 5 mm onto the culture soil in the jar using a spatula. Two seeds of soybean (cultivar “Ryokuheki”, Kaneko Seeds Co., Ltd.) were sown by burying at a depth of approximately 1 cm from the culture soil surface. 1 mL of a solution of 20 μM soyasaponin Bb (soyasaponin I, ChromaDex, Inc.) dissolved in 50 mM TAPS buffer (pH 7.7) was added dropwise onto the culture soil covering the seeds using a micropipette. The soyasaponin Bb concentration in the culture soil was approximately 0.3 ppm. Only 1 mL of 50 mM TAPS buffer as a negative control and 1 mL of 20 μM genistein (Gen) solution as a positive control of root nodule formation promotion were applied in the same way as above (for the root nodule formation-promoting effect of genistein, see: Plant and Soil, 1997, 192: 141-151; and Secretions and Exudates in Biological Systems 27-48, Signaling and Communication in Plants 12, Springer-Verlag Berlin Heidelberg, 2012).

Plant cultivation was performed under the same conditions as in Example 1. 24 days after the sowing, growth indexes (foliar age, plant height, the number of lateral buds, above-ground part fresh weight, underground part fresh weight, the number of root nodules, and root nodule fresh weight) were measured. Each growth index was obtained as to each test plot by determining a mean of two plant individuals in each jar, and subsequently calculating a mean of four jars (n=4). The Tukey-Kramer method was used to test the significant difference among the plots.

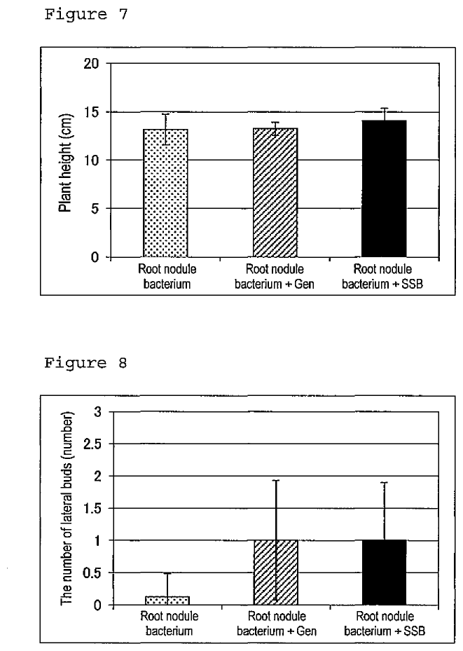

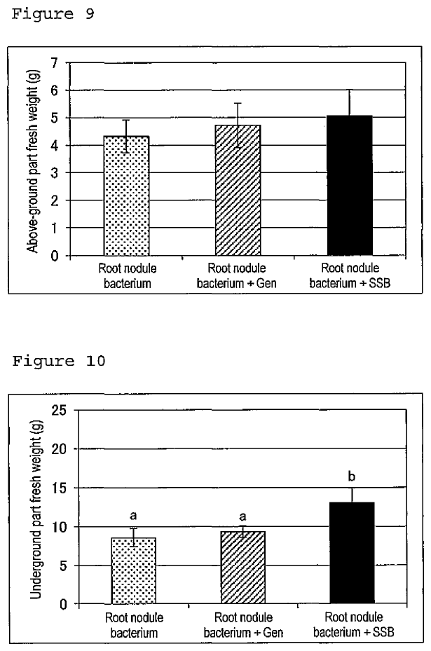

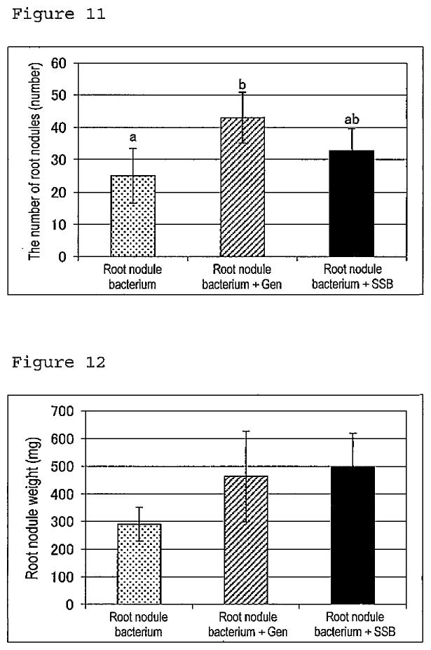

The measurement results are shown in FIGS. 6 to 12. In each figure, “+Gen” represents the genistein application plot, and “+SSB” represents the soyasaponin Bb application plot. In FIGS. 6 to 12, when significant difference was observed among means at a significance level of less than 5% by the significant difference test among the groups, alphabets (a, b and c) different from each other represented that there was a significant difference among the groups. Only in the soyasaponin Bb application plot, the underground part fresh weight was statistically significantly increased (approximately 1.5 times) with respect to the non-application plot (only the root nodule bacterium material) (FIG. 10). A tendency toward increase in above-ground part fresh weight was shown, albeit with no significant change, in the soyasaponin Bb application plot and the genistein application plot with respect to the non-application plot (FIG. 9). Lateral buds, which were rarely seen in the non-application plot, were observed at on average one per individual in the soyasaponin Bb application plot and the genistein application plot (FIG. 8). The number of root nodules was statistically significantly increased (approximately 1.7 times) only in the genistein application plot, whereas a favorable value (approximately 1.3 times) was obtained in the soyasaponin Bb application plot (FIG. 11). A tendency toward increase in root nodule weight was also seen, albeit with no significant difference, in both the soyasaponin Bb application plot and the genistein application plot (FIG. 12). The foliar age and the plant height did not differ significantly among the three plots, and their values were not decreased by the addition of soyasaponin Bb (FIGS. 6 and 7). The application of soyasaponin Bb and the root nodule bacterium material was confirmed to significantly increase the underground part weight, which is a growth index related to increase in the seed harvest of soybean (see Non Patent Literature 1), and a tendency toward increase in the number of root nodules and the root nodule weight, which are also related to increase in seed harvest (see Non Patent Literature 2) was observed. Therefore, it was expected that the application of soyasaponin Bb and the root nodule bacterium material to soybean is capable of increasing the seed harvest of soybean.

### Example 3

(Effect of Soyasaponin Bb-Containing Soybean Saponin Formulation on Soybean (Glycine max) Growth: Used in Combination with Root Nodule Bacterium Material)

A soybean saponin formulation containing approximately 10% (w/w) of soyasaponin Bb (“saponin, soybean-derived”; Wako Pure Chemical Industries, Ltd.) was added at a given concentration (0 ppm, 50 ppm, 100 ppm or 500 ppm) into a root nodule bacterium material (“Dr Mametaro®” (Idemitsu Kosan Co., Ltd.). Each Leonard jar filled with culture soil (Takii cell culture soil TM-1, Takii & Co., Ltd.) was watered overnight from the bottom. Then, approximately 2 g (wet weight) of the root nodule bacterium material to which the soybean saponin formulation had been added was distributed at a uniform thickness onto the culture soil in the jar. The soyasaponin Bb concentration in the culture soil was 0.15 to 1.5 ppm. A jar containing only the culture soil was provided as a control (non-application plot). One seed of soybean (cultivar “Yuagari Musume”, Kaneko Seeds Co., Ltd.) was sown by burying at a depth within approximately 1 cm from the surface.

Plant cultivation was performed under the same conditions as in Example 1. However, a nitrogen-free medium (Biochem J, 1971, 125: 1075-1080) diluted 10-fold with deionized water was added in an appropriate amount to the lower part of the jar approximately once per 7 to 10 days. 28 days after the sowing, growth indexes (foliar age, plant height, the number of lateral buds, above-ground part fresh weight, the number of root nodules, and root nodule fresh weight) were measured (n=4; n=3 only for 100 ppm of soybean saponin). The Tukey-Kramer method was used to test the significant difference among the plots.

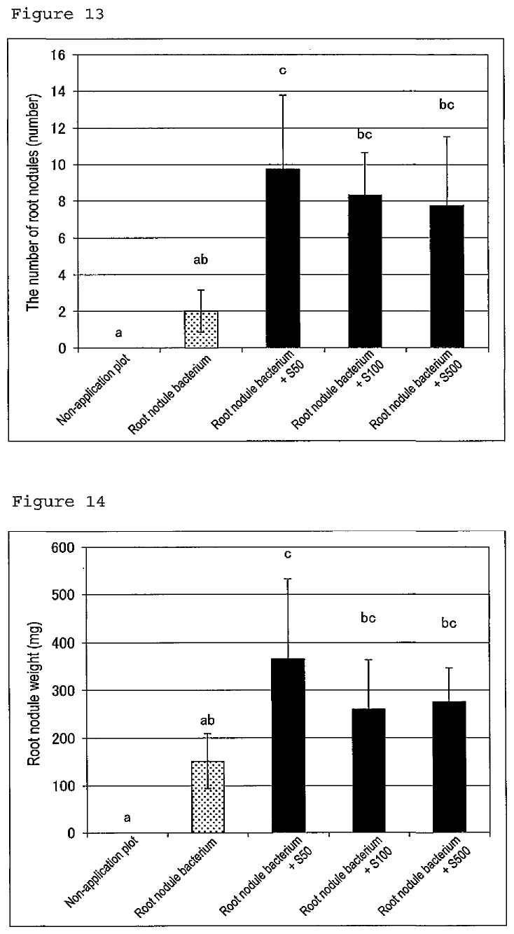

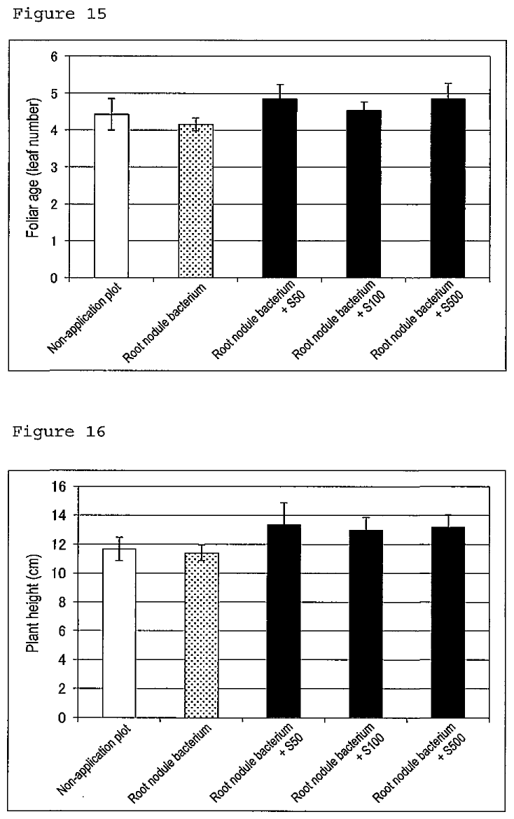

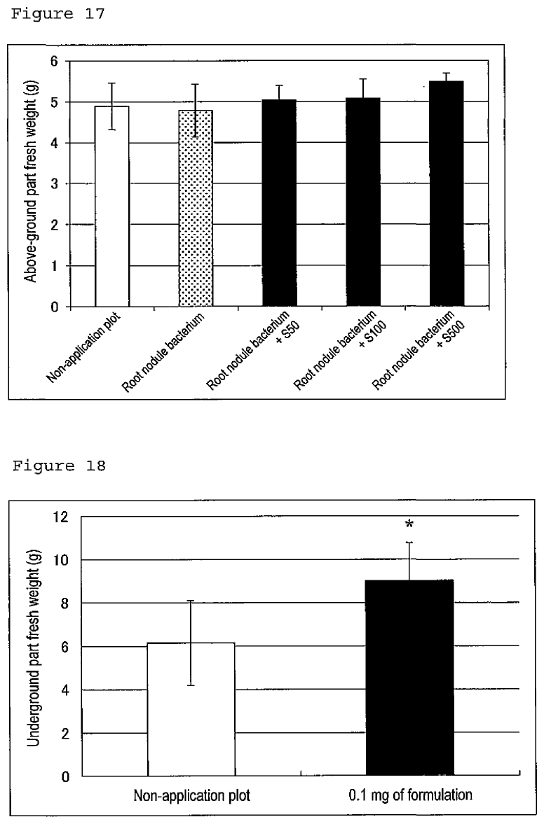

The measurement results are shown in FIGS. 13 to 17. In each figure, “+S50”, “+S100”, and “+S500” represent the soybean saponin formulation 50 ppm, 100 ppm, and 500 ppm application plots, respectively. In FIGS. 13 to 17, when significant difference was observed among means at a significance level of less than 5% by the significant difference test among the groups, alphabets (a, b and c) different from each other represented that there was a significant difference among the groups. No root nodule formation was observed in the soybean of the non-application plot cultivated in only the culture soil. In the case of applying only the root nodule bacterium material, the formation of approximately two root nodules per plant individual was seen. By contrast, the application of the root nodule bacterium material to which soybean saponin formulation had been added statistically significantly increased the number of root nodules to 3 times or more that in the application plot of only the root nodule bacterium material (FIG. 13). Likewise, the root nodule fresh weight per plant individual was also statistically significantly increased in the root nodule bacterium material application plot to which soybean saponin formulation had been added, compared with the application plot of only the root nodule bacterium material (FIG. 14). The largest increase in both the number of root nodules and the root nodule fresh weight was observed in the soybean saponin formulation 50 ppm addition plot. A tendency toward increase in the items of the other growth indexes, i.e., the foliar age, the plant height, and the above-ground part fresh weight, was observed, albeit with no significant change, in the soybean saponin formulation addition plot. The application of the root nodule bacterium material to which the soybean saponin formulation had been added was confirmed to significantly increase the number of root nodules and the root nodule weight, which are growth indexes related to increase in the seed harvest of soybean (see Non Patent Literature 2). Therefore, it is expected that the application of the root nodule bacterium material to which the soybean saponin formulation had been added, to soybean is capable of increasing the seed harvest of soybean.

### Example 4

### (Growth-Promoting Effect of Soyasaponin Bb-Containing Saponin Formulation)

“Fukuyutaka” (purchased from Nikko Seed Co., Ltd.) was used as soybean seeds. Each deep-type pot of 10 cm square was filled with approximately 1.5 L of culture soil (Takii water-containing cell culture soil, intermedium-acting fertilizer effect type:expanded vermiculite=1:1 (volume ratio)), and three seeds were sown at a depth of approximately 1 cm from the culture soil surface.

Aside from this, 1.5% of agar (Wako Pure Chemical Industries, Ltd.) was added to YM (yeast extract mannitol) medium (0.5 g of K₂HPO₄, 0.2 g of MgSO₄.7H₂O, 0.1 g of NaCl, 0.4 g of yeast extract, 10 g of mannitol, and 1 L of distilled water (pH 6.8)) to prepare an agar medium where a root nodule bacterium Bradyrhizobium japonicum NBRC14783T strain was then grown. An inoculating loop of the grown root nodule bacterium was inoculated to 5 mL of YM medium prepared in a test tube (capacity: 50 mL), and shake-cultured at a shaking speed of 250 rpm at 30° C. for 24 hours. 1 mL of the obtained root nodule bacterium culture solution was inoculated to 100 mL of YM medium of the same composition as above prepared in a Sakaguchi flask (capacity: 500 mL), and shake-cultured for approximately 72 hours. 1 mL of the root nodule bacterium culture solution in which the bacterium was proliferated until a value of turbidity OD600 of the bacterial body on the order of 0.3 was inoculated dropwise from above the sown seeds using a micropipette.

Subsequently, a solution of 500 ppm of a soybean saponin formulation (“soybean saponin 80”; AccessOne Co., Ltd.) dissolved in Milli Q water was prepared, and 0.2 mL of the solution was added dropwise from above the seeds using a micropipette (0.1 mg in terms of the soybean saponin formulation was added, and the concentration in the culture soil corresponded to approximately 0.067 ppm; and the concentration of group B soyasaponin in the culture soil corresponded to approximately 0.015 ppm by calculation from a content in the soybean saponin formulation quantified in Production Example 1 mentioned later). Only a solution of the bacterium was added dropwise to a negative control (“non-application plot”). After germination, soybean seedlings were thinned so as to attain one seedling per pot. The light conditions were set to 16-hour light/8-hour dark. The temperature was set to 25° C. Water supply was appropriately performed by the addition of tap water from the bottom. 31 days after the seed sowing, an underground part fresh weight, the number of root nodules, and a root nodule fresh weight were measured (n=6).

As a result of the Student's t test, approximately 46% significant (significance level: less than 5%) increase in underground part fresh weight was observed in the saponin formulation application plot with respect to the non-application plot (FIG. 18). A tendency toward approximately 19% increase in the number of root nodules was observed in the saponin formulation application plot with respect to the non-application plot, and a tendency toward approximately 6% increase in root nodule fresh weight was observed in the saponin formulation application plot with respect to the non-application plot.

### Example 5

(Effect of Soyasaponin Bb-Containing Soybean Saponin Formulation on Soybean (Glycine max) Yield: Applied by Soil Irrigation)

“Fukuyutaka” (purchased from Nikko Seed Co., Ltd.) was used as soybean seeds. Each Wagner pot of 1/5,000 a was filled with approximately 4 L of culture soil (Takii water-containing cell culture soil, intermedium-acting fertilizer effect type:expanded vermiculite=1:1 (volume ratio)), and three seeds were sown at a depth of approximately 1 cm from the culture soil surface. 50 mg of a saponin formulation (“soybean saponin 80”; AccessOne Co., Ltd.) or 5 mg of a purified saponin formulation prepared in Production Example 1 mentioned later was suspended in 100 mL of tap water, and the culture soil surface was irrigated with the suspension (the concentrations of the saponin formulation and the purified saponin formulation in the culture soil were approximately 12.5 ppm and approximately 1.25 ppm, respectively, and corresponded to approximately 6.1 ppm and approximately 0.9 ppm, respectively, in terms of the concentration of group B soyasaponin calculated from quantification results (Table 7) in Production Example 1). The culture soil was irrigated with only 100 mL of tap water as a negative control in the same way as above (“non-application plot”). 1 mL of a solution of a root nodule bacterium (root nodule bacterium Bradyrhizobium japonicum NBRC14783T strain) prepared in the same way as in Example 4 was added dropwise from above the sown seeds using a micropipette. After germination, soybean seedlings were thinned so as to attain two seedlings per pot. The light conditions were set to 16-hour light/8-hour dark up to the 47th day from the sowing and 12-hour light/12-hour dark on the 48th day or later. The temperature was set to 26° C. for light and 20° C. for dark, and the humidity was set to 50%. Water supply was performed by irrigation with tap water in an appropriate amount once per 2 to 4 days. 126 days after the sowing, the number of grains and a grain weight per pot were measured (n=5).

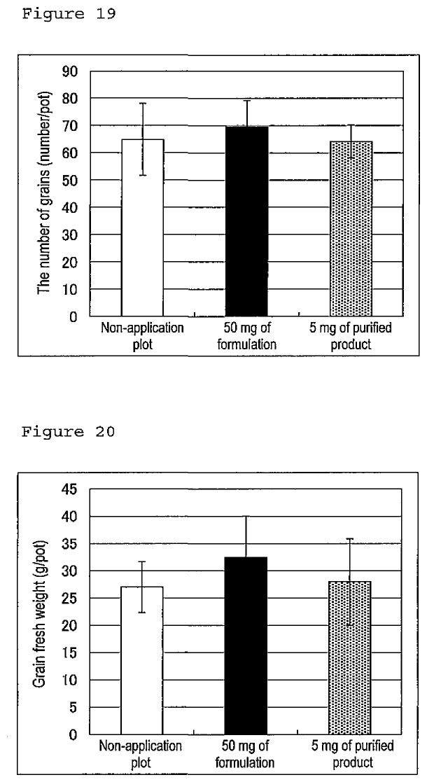

As a result of the multiple test (Tukey-Kramer method), significant difference in the number of grains and grain weight from the non-application plot was observed in neither the saponin formulation nor purified saponin formulation application plot, whereas a tendency toward increase in grain fresh weight per pot was shown with respect to the non-application plot (FIGS. 19 and 20). A harvest (mean±standard deviation) per 10 a calculated from a seed dry weight is shown in Table 2. The harvest of the saponin formulation 50 mg application plot was increased by 27% on average with respect to the non-application plot. The harvest of the test plot to which 5 mg of the purified saponin formulation had been applied was increased by 13%. No significant increase was seen in the number of pods and the number of grains by the application of the saponin formulation. On the other hand, the single grain weight was increased by 27% in the saponin formulation 50 mg application plot, suggesting that the increase in harvest by the application of the saponin formulation was mainly due to increase in single grain weight (Table 3).

TABLE 2

| | Non- | 50 mg | 5 mg |
|---|---|---|---|
| | application | (Soybean | (Purified saponin |
| | plot | saponin 80) | formulation) |
| Yield | 221 ± 35 | 281 ± 58 | 251 ± 43 |
| (kg/10 a) | | | |
| Rate of increase | 0 | 27 | 13 |
| compared to non- | | | |
| application plot (%) | | | |

TABLE 3

| | The number of | | The number of | | | |
|---|---|---|---|---|---|---|
| | pods/plant | | grains/plant | | Single grain weight | |
| | | Rate of | | Rate of | | Rate of |
| Test plot | Number | increase (%) | Number | increase (%) | g | increase (%) |
| Non-application plot | 44 ± 3 | 0 | 69 ± 5 | 0 | 129 ± 24 | 0 |
| 50 mg | 46 ± 4 | 5 | 68 ± 6 | −1 | 164 ± 25 | 27 |
| (Soybean saponin 80) | | | | | | |
| 5 mg | 44 ± 7 | 0 | 65 ± 6 | −6 | 156 ± 38 | 21 |
| (Purified saponin | | | | | | |
| formulation) | | | | | | |

### Example 6

(Effect of Soyasaponin Bb-Containing Soybean Saponin Formulation on Soybean (Glycine max) Yield: Applied by Seed Dressing)

“Ryokuheki” (Kaneko Seeds Co., Ltd.) was used as soybean seeds. Each Wagner pot of 1/5,000 a was filled with approximately 4 L of culture soil (Takii water-containing cell culture soil, intermedium-acting fertilizer effect type:expanded vermiculite=1:1 (volume ratio)), and three seeds were sown at a depth of approximately 1 cm from the culture soil surface. For the sowing, 25 mg or 50 mg of a saponin formulation powder (“soybean saponin 80”; AccessOne Co., Ltd.) was applied directly onto the seeds (the concentrations of the saponin formulation in the culture soil were approximately 6.25 ppm and approximately 12.5 ppm, respectively, and corresponded to approximately 3.1 ppm and approximately 6.1 ppm, respectively, in terms of the concentration of group B soyasaponin calculated from quantification results (Table 7) in Production Example 1 mentioned later). No saponin formulation was added to a negative control (“non-application plot”). 1 mL of a solution of a root nodule bacterium (root nodule bacterium Bradyrhizobium japonicum NBRC14783T strain) prepared in the same way as in Example 4 was added dropwise from above the sown seeds using a micropipette. After germination, soybean seedlings were thinned so as to attain one seedling per pot. The light conditions were set to 16-hour light/8-hour dark up to the 13th day from the sowing and 12-hour light/12-hour dark on the 14th day or later. The temperature was set to 26° C. for light and 20° C. for dark, and the humidity was set to 50%. Water supply was performed by irrigation with tap water in an appropriate amount once per 2 to 4 days. 73 days after the sowing, the number of grains and a grain weight per pot were measured (n=10).

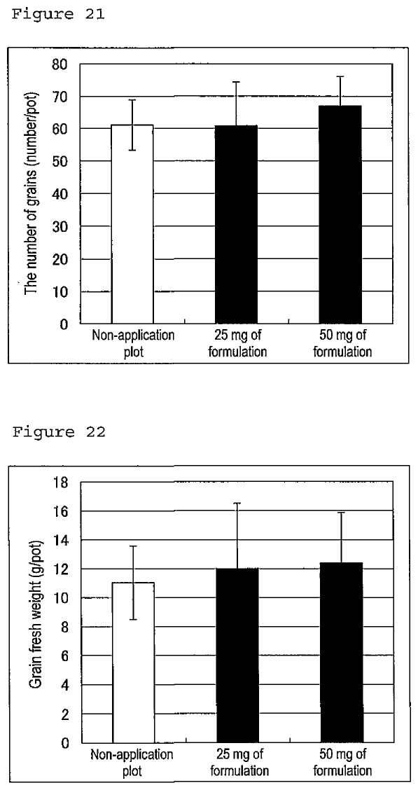

As a result of the multiple test (Tukey-Kramer method), significant difference in the number of grains and grain weight from the non-application plot was observed in neither the saponin formulation 25 mg nor 50 mg application plot, whereas a tendency toward increase in grain fresh weight was shown with respect to the non-application plot (FIGS. 21 and 22). A harvest (mean±standard deviation) per 10 a calculated from a seed dry weight is shown in Table 4. The harvests of the saponin formulation 25 mg and 50 mg application plots were increased by 9% and 12%, respectively, on average with respect to the non-application plot.

TABLE 4

| | Non- | 25 mg | 50 mg |
|---|---|---|---|
| | application | (Soybean | (Soybean |
| | plot | saponin 80) | saponin 80) |
| Yield | 551 ± 127 | 600 ± 225 | 619 ± 175 |
| (kg/10 a) | | | |
| Rate of increase | 0 | 9 | 12 |
| compared to non- | | | |
| application plot (%) | | | |

### Example 7

(Effect of Soyasaponin Bb-Containing Soybean Saponin Formulation on Soybean (Glycine max) Yield: Applied by Soil Incorporation into Field Soil)

“Fukuyutaka” (purchased from Nikko Seed Co., Ltd.) was used as soybean seeds. Each Wagner pot of 1/5,000 a was filled with approximately 4 L of Arakida soil adjusted to N:P:K=3.5:6:6 (in terms of kg/10 a) by the addition of “Mizuho chemical fertilizer No. 8” (SunAgro Co., Ltd.) and “Good phosphorus-potassium fertilizer” (Kotobuki Co., Ltd., Moji factory) at a weight ratio of 7:5. Subsequently, 50 mg of a saponin formulation (“soybean saponin 80”; AccessOne Co., Ltd.) was added directly onto the soil surface. Then, several cm of the surface layer was mixed using a spatula (the concentration of the saponin formulation in the culture soil was approximately 12.5 ppm and corresponded to approximately 6.1 ppm in terms of the concentration of group B soyasaponin calculated from quantification results (Table 7) in Production Example 1 mentioned later). No saponin formulation was added to a negative control (“non-application plot”). Three seeds were sown at a depth of approximately 1 cm from the culture soil. 1 mL of a solution of a root nodule bacterium (root nodule bacterium Bradyrhizobium japonicum NBRC14783T strain) prepared in the same way as in Example 4 was added dropwise from above the sown seeds using a micropipette. After germination, soybean seedlings were thinned so as to attain one seedling per pot. The light conditions were set to 16-hour light/8-hour dark up to the 13th day from the sowing and 12-hour light/12-hour dark on the 14th day or later. The temperature was set to 26° C. for light and 20° C. for dark, and the humidity was set to 50%. Water supply was performed by irrigation with tap water in an appropriate amount once per 2 to 4 days. 90 days after the sowing, a grain weight per pot was measured (n=6).

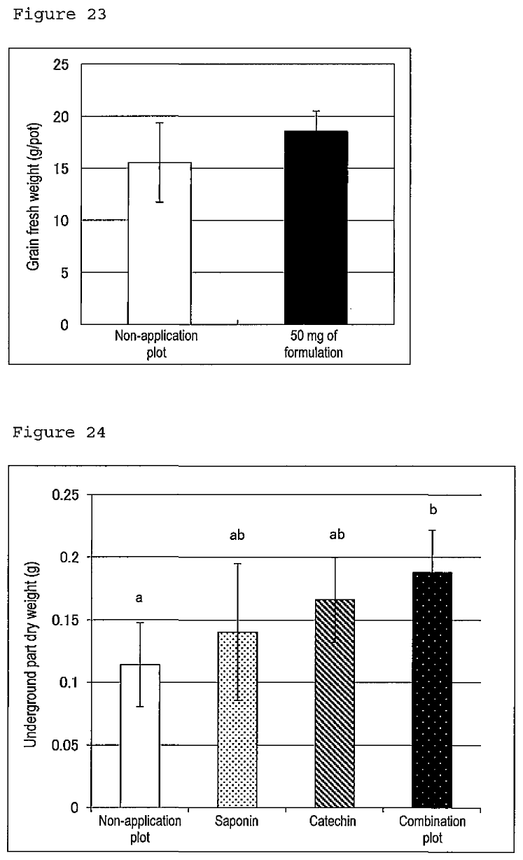

The grain fresh weight of the saponin formulation 50 mg application plot did not differ significantly (Tukey-Kramer method) from that of the non-application plot, but exhibited a tendency toward approximately 20% increase (FIG. 23). A harvest per 10 a calculated from a seed dry weight is shown in Table 5. The harvest of the saponin formulation 50 mg application plot was increased by 17% on average with respect to the non-application plot.

TABLE 5

| | Non-application | 50 mg |
|---|---|---|
| | plot | (Soybean saponin 80) |
| Yield | 301 ± 67 | 353 ± 32 |
| (kg/10 a) | | |
| Rate of increase compared | 0 | 17 |
| to non-application plot (%) | | |

### Example 8

(Effect of Soyasaponin Bb-Containing Soybean Saponin Formulation and Soil Conditioner Alkali-Treated Lignin Used in Combination on Soybean (Glycine max) Yield)

Increase in the yield of soybean was examined when aggregated soil was used and in addition, a saponin formulation was applied. “Yuagari Musume” (Kaneko Seeds Co., Ltd.) was used as soybean seeds. Soil of Arakida soil and bentonite mixed at a ratio of 95:5 and adjusted to N:P:K=6:6:6 (in terms of kg/10 a) by the addition of “Mizuho chemical fertilizer No. 8” (SunAgro Co., Ltd.) was used as cultivation soil. To this soil, 0.05% by mass of alkali-treated lignin having a soil-improving effect (produced according to Production Example 2 mentioned later (method of Production Example 1 described in the specification of JP-A-2017-190448 except that a portion of the process was omitted); hereinafter abbreviated to AL) was added and mixed by stirring to aggregate the soil. Polypots of 18 cm in diameter were filled with approximately 2 L each of the aggregated soil (+AL soil) and soil without aggregation treatment with AL (−AL soil). Two soybean seeds were sown at a depth of approximately 1 cm from the surface of each soil. Only for the +AL soil, 50 mg of a saponin formulation (“soybean saponin 80”; AccessOne Co., Ltd.) was further added directly to the soil surface, and several cm of the surface layer was mixed (the concentration of the saponin formulation in the soil was approximately 25 ppm, and corresponded to approximately 12.3 ppm in terms of the concentration of group B soyasaponin calculated from quantification results (Table 7) in Production Example 1 mentioned later). Cultivation was performed under natural light in an open field, and the pots were appropriately watered with tap water so as to be equal among the pots. 14 days after the sowing, two buds which appeared were thinned to make adjustment to one plant per pot. 111 days after the sowing, the number of pods per plant was measured (n=8).

The results are shown in Table 6. The number of pods per plant in the test plot cultivated using the −AL soil was 14.8 on average, whereas the number of pods per plant in the test plot cultivated by the application of 50 mg of the saponin formulation to the +AL soil was 16.6 on average and was thus increased by approximately 12%.

TABLE 6

| | The number of pods/plant | |
|---|---|---|
| Test plot | Number | Rate of increase (%) |
| −AL soil | 14.8 | 100.0 |
| −Saponin | | |
| +AL soil | 16.6 | 112.2 |
| +Saponin | | |

### Example 9

(Effect of Soyasaponin Bb-Containing Soybean Saponin Formulation and Catechin Used in Combination on Soybean (Glycine max) Growth)

Each Leonard jar (Soil Science and Plant Nutrition, 1983, 29: 97-100) filled with approximately 65 g of culture soil (Takii water-containing cell culture soil TM-1, Takii & Co., Ltd.) was watered overnight from the bottom. Then, one seed of soybean (cultivar “Fukuyutaka”, Nikko Seed Co., Ltd.) was sown by burying at a depth within approximately 1 cm from the surface. Aside from this, 1.5% of agar (Wako Pure Chemical Industries, Ltd.) was added to YM (yeast extract mannitol) medium (0.5 g of K₂HPO₄, 0.2 g of MgSO₄.7H₂O, 0.1 g of NaCl, 0.4 g of yeast extract, 10 g of mannitol, and 1 L of distilled water (pH 6.8)) to prepare an agar medium where a root nodule bacterium Bradyrhizobium japonicum NBRC14783T strain was then grown. An inoculating loop of the resulting bacterium was inoculated to 5 mL of YM medium prepared in a test tube (capacity: 50 mL), and shake-cultured at 250 rpm at 30° C. for 24 hours. Then, 1 mL of this root nodule bacterium culture solution was inoculated to 100 mL of YM medium prepared in a Sakaguchi flask (capacity: 500 mL), and shake-cultured at 120 rpm at 30° C. so that the bacterium was proliferated until. OD600 on the order of 0.3. 1 mL of the obtained root nodule bacterium culture solution was inoculated dropwise from above the sown seeds. A saponin formulation (“soybean saponin 80”; AccessOne Co., Ltd.) and a catechin formulation (“catechin mixture, green tea-derived”; Wako Pure Chemical Industries, Ltd.”; catechin content: 80%) were prepared into their respective aqueous solutions having a concentration of 100 ppm and into a saponin-catechin mixed aqueous solution having their respective final concentrations of 100 ppm, 200 μL each of which was then added dropwise from above the sown seeds (“saponin plot”, “catechin plot” and “combination plot”; both the concentrations of the saponin formulation of the saponin plot and the combination plot in the culture soil were approximately 0.16 ppm and corresponded to approximately 0.076 ppm in terms of the concentration of group B soyasaponin calculated from quantification results (Table 7) in Production Example 1). Only the root nodule bacterium culture solution was added dropwise and provided as a control (“non-application plot”).

Plant cultivation was performed using a plant growth chamber (LPH-411SP, Nippon Medical & Chemical Instruments Co., Ltd.). The light conditions were set to 12-hour light (light intensity: 130 μmol/m²/s)/12-hour dark. The temperature was set to 25° C. for light and 20° C. for dark, and the humidity was set to 50%. Water supply was performed appropriately (approximately once per 3 days) by the addition of tap water in an appropriate amount to the lower part of the Leonard jar. 26 days after the sowing, growth indexes (foliar age, plant height, above-ground part dry weight, underground part dry weight, the number of root nodules, and root nodule fresh weight) were measured (n=5 for the non-application plot and the saponin plot, and n=4 for the catechin plot and the combination plot).

The results of measuring the underground part dry weight are shown in FIG. 24. In FIG. 24, when significant difference was observed among means at a significance level of less than 5% by the significant difference test (Dunnett method) among the plots, alphabets (a and b) different from each other represented that there was a significant difference among the plots. The underground part dry weight was increased in the saponin plot and the catechin plot (by approximately 22% and approximately 45%, respectively) compared with the non-application plot. Furthermore, the underground part dry weight of the combination plot exhibited significant increase (approximately 64% increase, significance level: 5% or less) with respect to the non-application plot and was increased over that of the saponin plot and the catechin plot. No significant change in the other growth indexes was observed in use of both the agents in combination. The underground part weight is a growth index related to increase in the seed harvest of soybean (see Non Patent Literature 1). Therefore, it was expected that use of the soybean saponin formulation and catechin in combination is capable of further increasing the seed harvest of soybean.

### Example 10

(Effect of Soyasaponin Bb-Containing Soybean Saponin Formulation and Iron Phosphate Used in Combination on Soybean (Glycine max) Yield)

“Ryokuheki” (Kaneko Seeds Co., Ltd.) was used as soybean seeds. Each Wagner pot of 1/5,000 a was filled with approximately 4 L of culture soil (Takii water-containing cell culture soil, intermedium-acting fertilizer effect type:expanded vermiculite=1:1 (volume ratio)), and three seeds were sown at a depth of approximately 1 cm from the culture soil surface. 50 mg of a saponin formulation (“soybean saponin 80”; AccessOne Co., Ltd.), 0.75 mg of iron(III) phosphate tetrahydrate (Junsei Chemical Co., Ltd.), and a mixture thereof were each suspended in 100 mL of tap water, and the culture soil surface was irrigated with each suspension (“saponin plot”, “iron phosphate plot” and “combination plot”, respectively; both the concentrations of the saponin formulation of the combination plot and the saponin plot in the culture soil were approximately 12.5 ppm and corresponded to approximately 6.1 ppm in terms of the concentration of group B soyasaponin calculated from quantification results (Table 7) in Production Example 1). A control was irrigated with only 100 mL of tap water in the same way as above (“non-application plot”). 1 mL of a solution of a root nodule bacterium (root nodule bacterium Bradyrhizobium japonicum NBRC14783T strain) prepared in the same way as in Example 4 was added dropwise from above the sown seeds using a micropipette. After germination, soybean seedlings were thinned so as to attain one seedling per pot. The light conditions were set to 16-hour light/8-hour dark up to the 21st day from the sowing and 12-hour light/12-hour dark on the 22nd day or later. The temperature was set to 26° C. for light and 20° C. for dark, and the humidity was set to 50%. Water supply was performed by irrigation with tap water in an appropriate amount once per 2 to 4 days. 86 days after the sowing, pods (the pods include grains; the same holds true for the description below) were harvested, and a pod fresh weight per plant (pot) and a pod fresh weight per pod (average weight per pod) were measured (n=7 only for the combination plot, and n=8 for the other plots). The Williams test was used as a multiple test among the treatment plots.

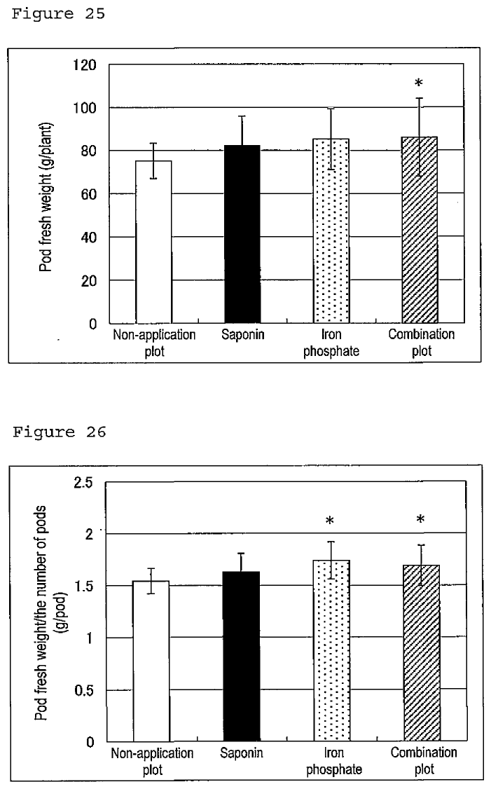

As a result of the measurement, the pod fresh weight per plant was increased by approximately 10% in each of the saponin plot and the iron phosphate plot with respect to the non-application plot and significantly increased in the combination plot (approximately 12% increase, significance level: 5% or less) with respect to the non-application plot (FIG. 25). The pod fresh weight per pod was significantly increased in the iron phosphate plot and the combination plot (approximately 10% increase, significance level: 5% or less) with respect to the non-application plot (FIG. 26).

### Example 11

(Effect of Soyasaponin Bb-Containing Soybean Saponin Formulation and Iron Phosphate Used in Combination on Yield of Soybean (Glycine max) Cultivated in Non-Cultivated Land Soil)

“Ryokuheki” (Kaneko Seeds Co., Ltd.) was used as soybean seeds. Each Wagner pot of 1/5,000 a was filled with approximately 4 L of soil (soil of non-cultivated land without fertilization, etc. collected from within Kao Corp., Tochigi office's premises), and three seeds were sown at a depth of approximately 1 cm from the culture soil surface. A mixture of 50 mg of a saponin formulation (“soybean saponin 80”; AccessOne Co., Ltd.) and iron(III) phosphate tetrahydrate (Junsei Chemical Co., Ltd.) was suspended in 100 mL of tap water, and the culture soil surface was irrigated with the suspension (“combination plot”; the concentration of the saponin formulation in the soil was approximately 12.5 ppm and corresponded to approximately 6.1 ppm in terms of the concentration of group B soyasaponin calculated from quantification results (Table 7) in Production Example 1). A control was irrigated with only 100 mL of tap water in the same way as above (“non-application plot”). The light conditions were set to 16-hour light/8-hour dark. The temperature was set to 26° C. for light and 20° C. for dark, and the humidity was set to 50%. Water supply was performed by irrigation with tap water in an appropriate amount once per 2 to 4 days. 83 days after the sowing, pods (the pods include grains; the same holds true for the description below) were harvested and dried overnight at 100° C., and a pod dry weight per pot and a dry weight of a grain alone were measured. Means of measurement items except for the largest and smallest values were calculated as to each treatment plot (n=5 for the combination plot, and n=4 for the non-application plot). The Student's t test was used to test the significant difference between the treatment plots.

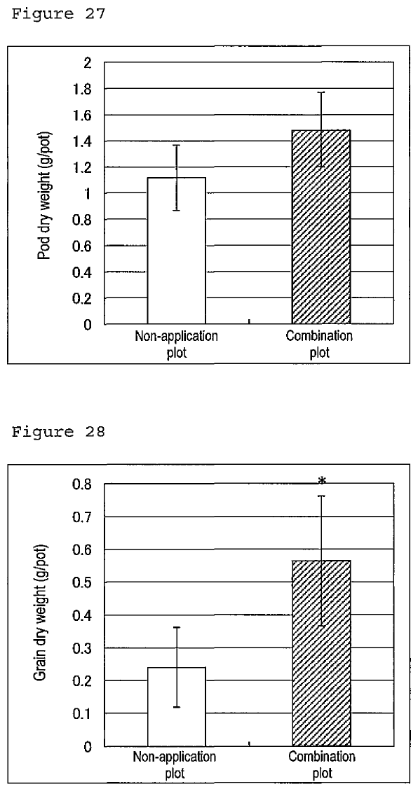

As a result of the measurement, the pod dry weight per pot of the combination plot was increased by approximately 30%, albeit with no significant difference, with respect to the non-application plot (FIG. 27). The grain dry weight was significantly increased in the combination plot (approximately 240% increase, significance level: 5% or less) with respect to the non-application plot (FIG. 28).

### Example 12

(Effect of Saponin Formulation on Leguminous Plant Other than Soybean)

Seeds of common bean (Phaseolus vulgaris) (cultivar “Nankyo Tsuru-nashi”; Nikko Seed Co., Ltd. and pea (Pisum sativum) (cultivar “Akahana Tsuru-nashi Kinusaya Endo”; purchased from Nikko Seed Co., Ltd.) were each sown at a depth of approximately 1 cm from culture soil surface in a nursery box (345 mm×270 mm×75 mm in height) filled with approximately 4 L of culture soil (Takii water-containing cell culture soil, intermedium-acting fertilizer effect type:expanded vermiculite=1:1 (volume ratio)). 8 days after the sowing, their respective young plant bodies were removed from the culture soil, and the roots were washed with running water. One each of the individuals was transferred to each 50 mL screw tube filled with 50 mL of a Hoagland nutrient solution (prepared using Hoagland Modified Basal Salt Mixture (PhytoTechnology Laboratories, LLC)) diluted to predetermined 5-fold concentrations. A saponin formulation (“soybean saponin 80”; AccessOne Co., Ltd.) was added at a final concentration of 0 ppm (“non-application plot”), 10 ppm (“10 ppm application plot”) or 100 ppm (“100 ppm application plot”) to the Hoagland nutrient solution in the screw tube (the concentration of group B soyasaponin in the nutrient solution corresponded to 0 ppm, approximately 4.9 ppm and approximately 49.1 ppm in terms of a converted concentration from quantification results (Table 7) in Production Example 1). Five samples each of common bean and pea were provided as to each application plot. Plant cultivation was performed in a plant growth chamber. The light conditions were set to 16-hour light/8-hour dark. The temperature was set to 26° C. for light and 20° C. for dark, and the humidity was set to 50%. The nutrient solution was replaced with a fresh one free from the saponin formulation every 7 days. 14 days after the transfer to the nutrient solution, an above-ground part fresh weight and an underground part fresh weight were measured. The Dunnett test was used as a multiple test among the treatment plots.

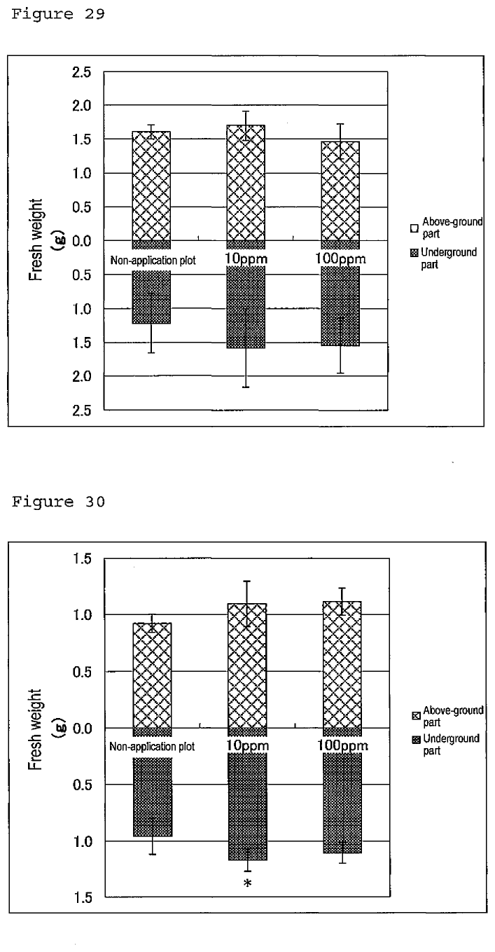

As a result of the measurement, both the underground part fresh weights of the saponin formulation 10 ppm application plot and 100 ppm application plot for common bean were increased by approximately 1.3 times with respect to the non-application plot (FIG. 29). The underground part fresh weight was significantly increased in the saponin formulation 10 ppm application plot for pea (approximately 20% increase, significance level: 5% or less) with respect to the non-application plot, and approximately 15% increase was also observed in the 100 ppm application plot (FIG. 30). 18% or more increase in above-ground part fresh weight was seen in the saponin application plot for pea with respect to the non-application plot (FIG. 30).

### Example 13

(Effect of Promoting Soybean (Glycine max) and Chickpea (Cicer arietinum) Growth by Foliar Application of Saponin Formulation)

Seeds of soybean (cultivar “Fukuyutaka”; purchased from Nikko Seed Co., Ltd.) and chickpea (unknown cultivar (Kabuli type); purchased from Nikko Seed Co., Ltd.) were each sown at a depth of approximately 1 cm from culture soil surface in a nursery box (270 mm in length×345 mm in width×75 mm in height) filled with approximately 4 L of culture soil (Takii water-containing cell culture soil, intermedium-acting fertilizer effect type:expanded vermiculite=1:1 (volume ratio)). For the sowing, 5 and 9 soybean seeds were arranged longitudinally and laterally, respectively, at equal spaces of approximately 1 cm, and 4 and 9 chickpea seeds were arranged longitudinally and laterally, respectively, at equal spaces of approximately 1 cm. The nursery box was placed on a tray, and the tray was watered by appropriately supplying tap water. Cultivation was performed in a plant growth chamber. The light conditions were set to 16-hour light/8-hour dark. The temperature was set to 26° C. for light and 20° C. for dark, and the humidity was set to 50%. A group of 5 longitudinally arranged and 3 laterally arranged plant bodies was used as one unit for soybean. A group of 4 longitudinally arranged and 3 laterally arranged plant bodies was used as one unit for chickpea. Three units each of the plant species were subjected to the following foliar application treatment (because of the presence of individuals which failed to be germinated, the actual number of samples was in the range of n 10 to 15 as mentioned later).

In the foliar application, a saponin formulation (“soybean saponin 80”; AccessOne Co., Ltd.) was added at a final concentration of 0 ppm (“non-application plot”), 10 ppm (“10 ppm application plot”) or 100 ppm (“100 ppm application plot”) to an aqueous solution containing 0.05% by mass (final concentration) of a spreading agent Approach BI (Kao Corp.), and used as a treatment solution. 13 days after the sowing of each plant species, each of these treatment solutions was sprayed (approximately 5 mL/unit) to the above-ground part of each unit using a sprayer (the applied concentrations of the saponin formulation contained in the culture soil of each unit corresponded to approximately 0.018 ppm and 0.18 ppm in terms of the concentration of group B soyasaponin calculated from quantification results (Table 7) in Production Example 1). For the spraying, a paper partition was created between the units to prevent the treatment solution from flying to different units.

9 days after the foliar application treatment, the above-ground part fresh weight of each plant individual was measured (as for soybean, n=14 for the non-application plot, n=15 for the 10 ppm application plot, and n=14 for the 100 ppm application plot; as for chickpea, n=11 for the non-application plot, n=10 for the 10 ppm application plot, and n=11 for the 100 ppm application plot). The Dunnett test was used as a multiple test among the treatment plots.

The appearance of the root of each plant species elongating from the bottom of the nursery box was photographed. From the taken image, the area of the root elongation region (root spread) in each application plot was analyzed as described below using open source image analysis software ImageJ and digitized. First, the taken image was split into RGB by the function “Split Channels” of ImageJ. The prepared “red” image was used, and an analysis region (length (270 mm) and width (345 mm) of the nursery box) in the image was split at equal spaces by a line of 3 pixels in width and thereby divided into a total of 1536 sections formed by the points of intersection of the lines. The length of 1 pixel in the image corresponded to 0.013 cm in the soybean image and 0.012 cm in the chickpea image. A region having brightness equal to or higher than a threshold in each section was determined as a root. The threshold (item “Threshold”) of brightness in the software for identifying the root part was set to 106-255 for soybean and 116-255 for chickpea. The threshold setting was performed according to a routine method while the selection of an appropriate range on the image was visually confirmed (reference: Tajima, Root Research 23 (3): 75-81 (2014)). From the brightness data, the area of the root elongation region was measured by the execution of “Analyze Particles”. In this operation, the item “Size” in the software was set to 0-100000 (cm²), and the item “Circularity” was set to 0.01-1.00. From the measurement results, a relative value was determined when the root spread of the non-application plot was defined as 1.

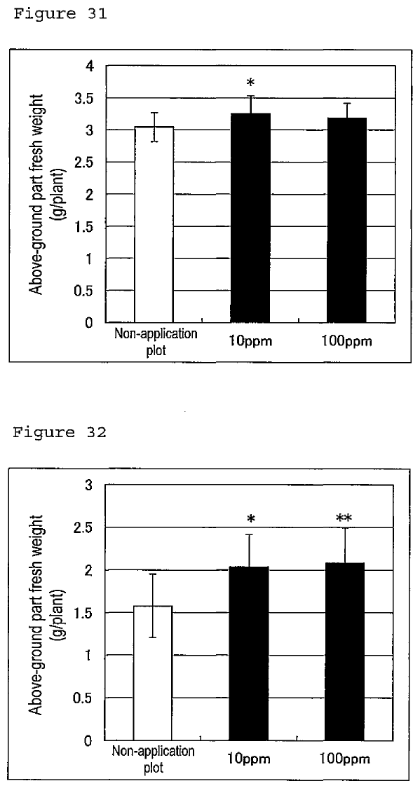

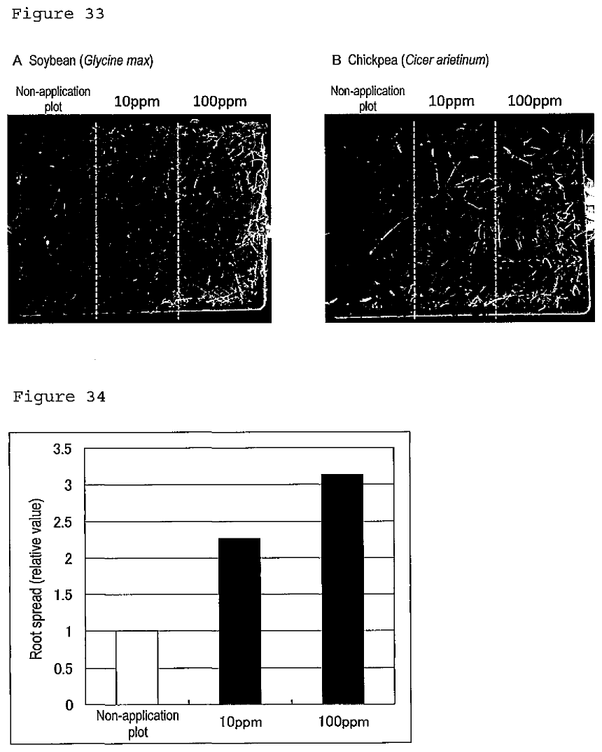

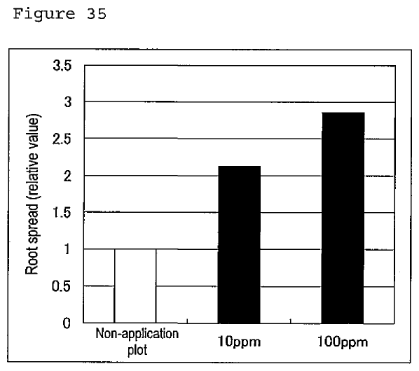

As a result of the measurement, the above-ground part fresh weight was significantly increased in the 10 ppm application plot for soybean (approximately 7% increase, significance level: 5% or less) with respect to the non-application plot (FIG. 31). The above-ground part fresh weight was significantly increased in the 10 ppm application plot and the 100 ppm application plot for chickpea (approximately 30% increase, significance level: 5% or less and 1% or less, respectively) with respect to the non-application plot (FIG. 32). Increase in root spread was observed in the saponin application plot compared with the non-application plot for both soybean and chickpea (FIGS. 33A and 33B). As a result of digitizing the root spread of each application plot as to each plant species, approximately 2.3-fold increase and approximately 3.1-fold increase in root spread were observed in the 10 ppm application plot and the 100 ppm application plot, respectively, for soybean with respect to the non-application plot (FIG. 34). Also, approximately 2.1-fold increase and approximately 2.9-fold increase in root spread were observed in the 10 ppm application plot and the 100 ppm application plot, respectively, for chickpea with respect to the non-application plot (FIG. 35).

### Production Example 1

1) Purification of Saponin Formulation

4.99 g of a soybean saponin formulation (“soybean saponin 80”; AccessOne Co., Ltd.) was dissolved in 300 mL of 40 v/v % ethanol, and the solution was centrifuged to recover a supernatant. A glass column was packed with 500 mL of a synthetic adsorbent HP-20 (Mitsubishi Chemical Corp.), which was then activated with ethanol. The supernatant was applied to the column equilibrated with 40 v/v % ethanol, followed by elution with 1,000 mL of 40 v/v % ethanol, subsequently 1,000 mL of 60 v/v % ethanol, and finally 1,000 mL of 99.5 v/v % ethanol. Each eluate was concentrated under reduced pressure and subsequently freeze-dried. Since a relatively large amount of group B soyasaponin was transferred to the 60 v/v % ethanol elution fraction, the group B soyasaponin was then purified from the 60 v/v % ethanol fraction. 0.87 g of the freeze-dried 60 v/v % ethanol fraction was redissolved in 200 mL of 60 v/v % ethanol. To this solution, 1.0 g of active carbon (Shirasagi P, Osaka Gas Chemicals Co., Ltd.) was added, and the mixture was stirred for 1 hour using a stirrer. The mixture was filtered through a PTFE filter, and the filtrate was concentrated under reduced pressure and then further freeze-dried to obtain a purified saponin formulation powder. The contents of the group B soyasaponin in the soybean saponin formulation and the obtained purified saponin formulation were determined by the following procedures.

2) Quantification of Group B Soyasaponin by LC-MS

<LC-MS Analysis Conditions>

The HPLC apparatus and the mass spectrometry apparatus used were Shimadzu Nexera UHPLC system (Shimadzu Corp.) and Triple Quad 4500 system (AB Sciex Pte. Ltd.), respectively. The columns used, were Capcell Core C18 (2.1×50 mm, 2.7 μm) and a guard column Capcell Core C18 (2.1×5 mm, 2.7 μm) (Shiseido Co., Ltd.). The eluant used was A: 0.1 v/v % aqueous formic acid solution and B: acetonitrile. The gradient conditions were set to 0 minutes to 1 minute (10 v/v % B)→1 minute to 7 minutes (1 v/v % B to 47.5 v/v % B)→7 minutes to 9 minutes (47.5 v/v % B to 85 v/v % B)→9 minutes to 9.01 minutes (85 v/v % B to 100 v/v % B)→9.01 minutes to 10 minutes (100 v/v % B)→10 minutes to 10.01 minutes (100 v/v % B to 10 v/v % B)→10.01 minutes to 11 minutes (10 v/v % B). The flow rate was set to 0.5 mL/min. The detection method used was MRM (multiple reaction monitoring) and was performed on a positive mode as polarity.

<Reagents>

The standard products (product number, supplier) used were soyasaponin I (P2505, Tokiwa Phytochemical Co., Ltd.), soyasaponin II (NP-000100, AnalytiCon Discovery GmbH) and soyasaponin V (P2506, Tokiwa Phytochemical Co., Ltd.) as group B soyasaponin. A calibration curve was prepared as to each of these soyasaponins.

<Sample>

Soybean saponin formulation (“saponin, soybean-derived”; Wako Pure Chemical Industries, Ltd.) used in Example 3

Soybean saponin formulation (“soybean saponin 80”; AccessOne Co., Ltd.) used in Example 4

Purified saponin formulation obtained in 1) described above.

<Quantification>

Soyasaponins I, II and V contained in each sample were quantified from the calibration curves. The total amount (% by mass) of the group B soyasaponin in each formulation calculated from the quantification values is shown in Table 7.

TABLE 7

| | | | Purified saponin |
|---|---|---|---|
| | Saponin, | Soybean | formulation |
| | soybean-derived | saponin 80 | (purified product |
| | (Wako Pure Chemical | (AccessOne | of soybean |
| | Industries, Ltd.) | Co., Ltd.) | saponin 80) |
| Content of | 22.8 | 49.1 | 75.3 |
| group B | | | |
| soyasaponin | | | |
| (% by mass) | | | |

### Production Example 2

Alkali-treated lignin (lignin decomposition product) serving as a soil-aggregating agent was produced by the following steps 1 and 2 according to the description of JP-A-2017-190448.

<Step 1>

30 g (dry mass) of sugarcane (Saccharum officinarum) bagasse was placed as herbal biomass in a glass bottle, and an aqueous solution containing 1.6% by mass of sodium hydroxide was added thereto such that the solid content was 10% by mass. The glass bottle was heated at 95° C. for 6 hours in an autoclave to obtain a reaction product.

<Step 2>

The reaction product obtained in step 1 was filtered under reduced pressure using a 400-mesh SUS mesh and Nutsche. The residue was washed with 300 mL of ion-exchanged water of 90° C. The filtrate and the washes were collected and adjusted to pH 4 with 1.0 M hydrochloric acid to obtain a suspension containing a lignin decomposition product.

The suspension obtained in step 2 was centrifuged. The centrifugation was performed under conditions of 10,000 rpm and 20 minutes using “himac CR 20G III” manufactured by Hitachi Koki Co., Ltd. After the centrifugation, the supernatant was removed, and 300 mL of ion-exchanged water was added to the residue, followed by stirring. Then, centrifugation was performed again under the same conditions as above, and the resultant was washed with water. The washing with water was performed twice, and the obtained precipitate was freeze-dried to obtain alkali-treated lignin (lignin decomposition product) in a powder form.

1-5. (canceled)

6. A method for promoting the growth of a leguminous plant comprising using a glycoside of soyasapogenol B as an active ingredient, the glycoside having a hydroxy group at position C-22 of the soyasapogenol B and having a saccharide bonded to a hydroxy group at position C-3 of the soyasapogenol B.

7. The method according to claim 6, comprising cultivating the leguminous plant with the glycoside of soyasapogenol B.

8. The method according to claim 7, comprising:
adding a pesticide, a fertilizer, a microbial material, a soil conditioner, a material for sowing or a supplement for plants comprising the glycoside of soyasapogenol B as an active ingredient to a cultivation substrate; and
cultivating the leguminous plant in the obtained cultivation substrate to which the glycoside is added.

9. The method according to claim 7, comprising:
coating or smearing a leguminous plant seed before sowing with a pesticide, a fertilizer, a microbial material, a soil conditioner, a material for sowing or a supplement for plants comprising the glycoside of soyasapogenol B as an active ingredient; and
cultivating the seed in a cultivation substrate.

10. The method according to claim 7, comprising:
distributing or spraying a pesticide, a fertilizer, a microbial material, a soil conditioner, a material for sowing or a supplement for plants comprising the glycoside of soyasapogenol B as an active ingredient to a leguminous plant body, or coating the leguminous plant body therewith; and
cultivating the plant body in a cultivation substrate.

11. The method according to claim 8, wherein the pesticide, the fertilizer, the microbial material, the soil conditioner, the material for sowing or the supplement for plants comprises from 0.0005 to 80% by mass of the glycoside of soyasapogenol B.

12. The method according to claim 7, wherein for the cultivation, a concentration of the glycoside of soyasapogenol B in the cultivation substrate is from 0.01 to 100 ppm by mass.

13. The method according to claim 6, wherein the glycoside of soyasapogenol B is soyasaponin Bb.

14. The method according to claim 6, wherein the leguminous plant is at least one member selected from the group consisting of a plant of the genus Glycine, a plant of the genus Phaseolus, a plant of the genus Cicer, a plant of the genus Pisum, a plant of the genus Lens, a plant of the genus Cajanus, a plant of the genus Vicia, and a plant of the genus Arachis.

15. The method according to claim 14, wherein the leguminous plant is at least one member selected from the group consisting of soybean (Glycine max), common bean (Phaseolus vulgaris), chickpea (Cicer arietinum), pea (Pisum sativum), lentil (Lens culinaris), pigeon pea (Cajanus cajan), broad bean (Vicia faba) and peanut (Arachis hypogaea).

16. The method according to claim 6, wherein soil or culture soil aggregated using alkali-treated lignin is used as a cultivation substrate.

17. The method according to claim 6, wherein the glycoside of soyasapogenol B is used in combination with a catechin or iron(III) phosphate.

18-24. (canceled)

25. The method according to claim 15, wherein the leguminous plant is soybean (Glycine max).
